(19) United States
(12) Patent Application Publication
(10) Pub. No.: US 2026/0156682 A1
(43) Pub. Date: Jun. 4, 2026

(54) DYNAMIC ADAPTATION OF PHYSICAL RANDOM ACCESS CHANNEL TRANSMISSIONS

(71) Applicant: QUALCOMM Incorporated, San Diego, CA (US)

(72) Inventors: Mohammed JABI, San Diego, CA (US); Ahmed Attia ABOTABL, San Diego, CA (US); Muhammad Sayed Khairy ABDELGHAFFAR, San Jose, CA (US)

(21) Appl. No.: 18/967,951

(22) Filed: Dec. 4, 2024

(51) Int. Cl. H04W 74/0833; H04W 76/38

(52) U.S. Cl. CPC H04W 74/0833; H04W 76/38

(57) ABSTRACT

Various aspects of the present disclosure generally relate to wireless communication. In some aspects, a user equipment (UE) may transmit first repetitions of a physical random access channel (PRACH) preamble during first random access channel (RACH) occasion (RO) groups, where the first RO groups include a first set of ROs that are mapped to a synchronization signal block (SSB). The UE may receive control information that activates a second set of ROs, where the second set of ROs are mapped to the SSB. The UE may transmit, after activating the second set of ROs, second repetitions of the PRACH preamble during second RO groups that include the first set of ROs and the second set of ROs, and where a starting time to begin forming the second RO groups is in accordance with RO grouping rules. Numerous other aspects are described.

### FIELD OF THE DISCLOSURE

Aspects of the present disclosure generally relate to wireless communication and specifically relate to techniques, apparatuses, and methods associated with dynamic adaptation of physical random access channel (PRACH) transmissions.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples, a user equipment (UE) may perform a random access procedure (e.g., a random access channel (RACH) procedure) with a network node to enable the UE to establish a connection with the network node, such as for an initial access, a link recovery, and/or a beam failure recovery, among other examples. The RACH procedure may include the exchange of one or more random access messages between the UE and the network node. For example, the UE may transmit a preamble, such as a physical RACH (PRACH) preamble. In some examples, the UE may utilize resources that are configured (such as via system information signaling or radio resource control (RRC) signaling) for initiating random access procedures with the network node.

### SUMMARY

Some aspects described herein relate to a user equipment (UE) for wireless communication. The UE may include one or more memories and one or more processors coupled to the one or more memories. The one or more processors may be configured to transmit, to a network node, one or more first repetitions of a physical random access channel (PRACH) preamble during one or more first random access channel (RACH) occasion (RO) groups, wherein the one or more first RO groups include a first set of ROs that are mapped to a synchronization signal block (SSB). The one or more processors may be configured to receive, from the network node, control information that activates a second set of ROs, wherein the second set of ROs are mapped to the SSB. The one or more processors may be configured to transmit, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules.

Some aspects described herein relate to a method of wireless communication performed by a UE. The method may include transmitting, to a network node, one or more first repetitions of a PRACH preamble during one or more first RO groups, wherein the one or more first RO groups include a first set of ROs that are mapped to an SSB. The method may include receiving, from the network node, control information that activates a second set of ROs associated with dynamically activated capability, wherein the second set of ROs are mapped to the SSB. The method may include transmitting, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules.

Some aspects described herein relate to an apparatus for wireless communication. The apparatus may include means for transmitting, to a network node, one or more first repetitions of a PRACH preamble during one or more first RO groups, wherein the one or more first RO groups include a first set of ROs that are mapped to an SSB. The apparatus may include means for receiving, from the network node, control information that activates a second set of ROs, wherein the second set of ROs are mapped to the SSB. The apparatus may include means for transmitting, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules.

Some aspects described herein relate to a non-transitory computer-readable medium that stores a set of instructions for wireless communication by a UE. The set of instructions, when executed by one or more processors of the UE, may cause the UE to transmit, to a network node, one or more first repetitions of a PRACH preamble during one or more first RO groups, wherein the one or more first RO groups include a first set of ROs that are mapped to an SSB. The set of instructions, when executed by one or more processors of the UE, may cause the UE to receive, from the network node, control information that activates a second set of ROs, wherein the second set of ROs are mapped to the SSB. The set of instructions, when executed by one or more processors of the UE, may cause the UE to transmit, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of selection of a number of repetitions for transmitting a random access (RA) message, in accordance with the present disclosure.

FIG. 4 is a diagram illustrating an example of random access channel (RACH) occasion groups, in accordance with the present disclosure.

FIG. 5A is a diagram illustrating an example of a RACH occasion group formation associated with a single set of RACH occasions, in accordance with the present disclosure.

FIG. 5B is a diagram illustrating an example of a RACH occasion group formation associated with a multiple sets of RACH occasions, in accordance with the present disclosure.

FIG. 6A is a diagram illustrating an example associated with forming joint RACH occasion (RO) groups after activation of dynamically activated ROs, in accordance with the present disclosure.

FIG. 6B is a diagram illustrating an example associated with forming joint RO groups during a next association pattern period after activation of the dynamically activated ROs, in accordance with the present disclosure.

FIG. 6C is a diagram illustrating an example associated with forming joint RO groups after a current active RO group pattern and after activation of the dynamically activated ROs, in accordance with the present disclosure.

FIG. 7A is a diagram illustrating an example associated with forming independent RO groups after activation of dynamically activated ROs, in accordance with the present disclosure.

FIG. 7B is a diagram illustrating an example associated with forming independent RO groups during a next association pattern period after activation of dynamically activated ROs, in accordance with the present disclosure.

FIG. 7C is a diagram illustrating an example associated with forming independent RO groups after a current active RO group pattern and after activation of the dynamically activated ROs, in accordance with the present disclosure.

FIG. 8 is a diagram illustrating an example associated with dynamic adaptation of physical RACH transmissions, in accordance with the present disclosure.

FIG. 9 is a diagram illustrating an example process performed, for example, at a user equipment (UE) or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

To enhance uplink coverage and address issues associated with weak signal conditions, a user equipment (UE) may transmit repetitions of one or more random access messages during a random access channel (RACH) procedure. As used herein, “repetition” may refer to an initial transmission of a message and also to a repeated transmission of the message. Thus, each transmission (regardless of whether the transmission is an initial transmission or a retransmission) may be referred to as a repetition. For example, the UE may transmit multiple instances of a random access message (e.g., of a physical RACH (PRACH) preamble) in one or more time intervals. This repetition increases the likelihood that at least one transmission of the random access message will be successfully received by the network node, thereby improving the robustness and/or reliability of the random access message. The network node may combine multiple transmissions (e.g., repetitions) of the random access message to improve the reliability of the random access message, such as for a UE located at an edge of a cell coverage area associated with the network node.

To enable repetitions of a random access message (e.g., to enable the network node to reliably identify and/or combine repetitions of a random access message), RACH occasions (ROs) may be organized into RO groups. As used herein, “occasion” refers to one or more resources (e.g., time domain resources, frequency domain resources, spatial domain resources, code domain resources, and/or other resources) that are available for, or configured for, the communication (e.g., the transmission and/or the reception) of a communication or message (e.g., an RO may be one or more resources available for, or configured for, the communication of a random access message). An RO group may include multiple ROs. “RO group” may be used interchangeably with “set of ROs” herein. The configuration or organization of RO groups may enable the network node to identify and/or combine repetitions of a random access message. For example, if a UE is configured to transmit repetitions of a random access message, then the UE may transmit the repetitions during respective ROs included in a given RO group. This enables the network node to identify the ROs in which the repetitions of the random access message are to be transmitted. This organization enables the network node to correctly and/or reliably detect, identify, and/or combine the multiple repetitions of the random access message for efficient signal processing and accurate detection.

The management of RACH configurations and repetitions enables efficient network performance and robust uplink coverage. However, the introduction of a network energy savings (NES) capability (or other dynamic capabilities) may introduce complexities for RO configurations and/or for forming RO groups for repetitions of a random access message. For example, UEs that support a dynamic capability (e.g., NES-capable UEs) may consider or identify ROs associated with the dynamic capability (e.g., NES ROs). UEs that do not support the dynamic capability (e.g., referred to herein as “non-NES-capable” UEs or “legacy” UEs) may not be configured or identify ROs associated with the dynamic capability. Therefore, there may be discontinuity between RACH procedures for UEs of different dynamic capabilities, which may increase complexity and discontinuity in the performance of RACH procedures across different types of UEs.

Additionally, the network node may activate dynamically activated ROs via dynamic control signaling. For example, the network node may initially activate a set of ROs that are not associated with dynamic capabilities (e.g., referred to herein as “traditional” ROs), and may indicate that the dynamically activated ROs are initially deactivated. Therefore, the UE may form RO groups that exclusively include traditional ROs while the dynamically activated ROS are deactivated. If, however, the UE is currently in a process of forming RO groups when the dynamically activated ROs are activated, the UE may be unaware of a time at which to begin forming RO groups that include dynamically activated ROs, which may cause the UE to skip one or more valid dynamically activated ROs during RO group formation. By skipping one or more valid dynamically activated ROs, the UE may reduce the efficiency of resource utilization, which may increase the latency associated with performing RACH procedures. Additionally, the UE may be unaware of whether to form RO groups that include both traditional ROs and dynamically activated ROs (e.g., joint-RO groups) or whether to form RO groups that exclusively include traditional ROs or exclusively include dynamically activated ROs (e.g., independent RO groups). Therefore, the UE may mismanage the formation of RO groups, which may result in miscommunication between the UE and the network node.

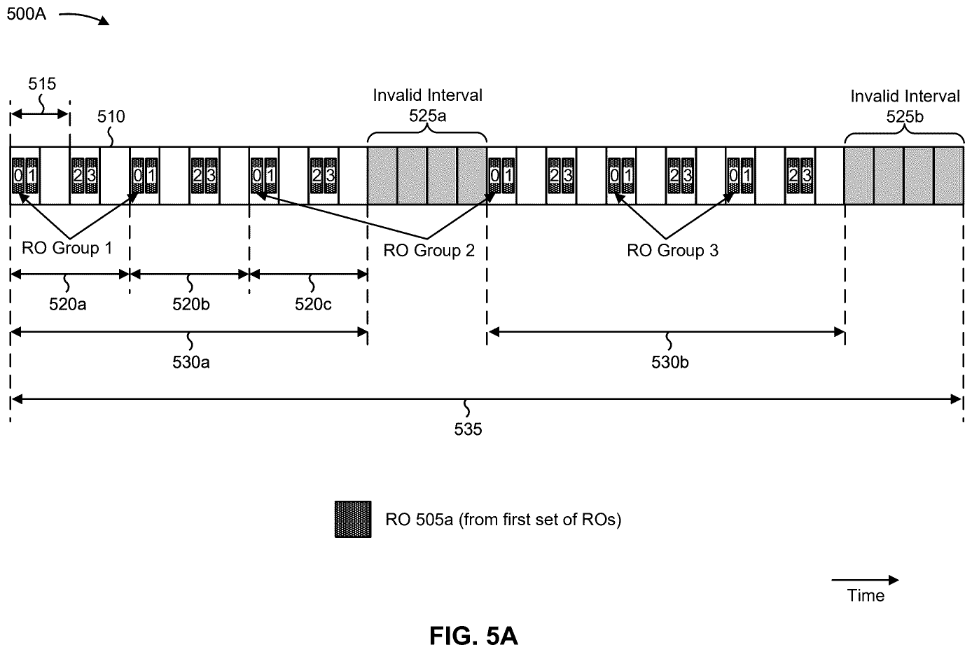

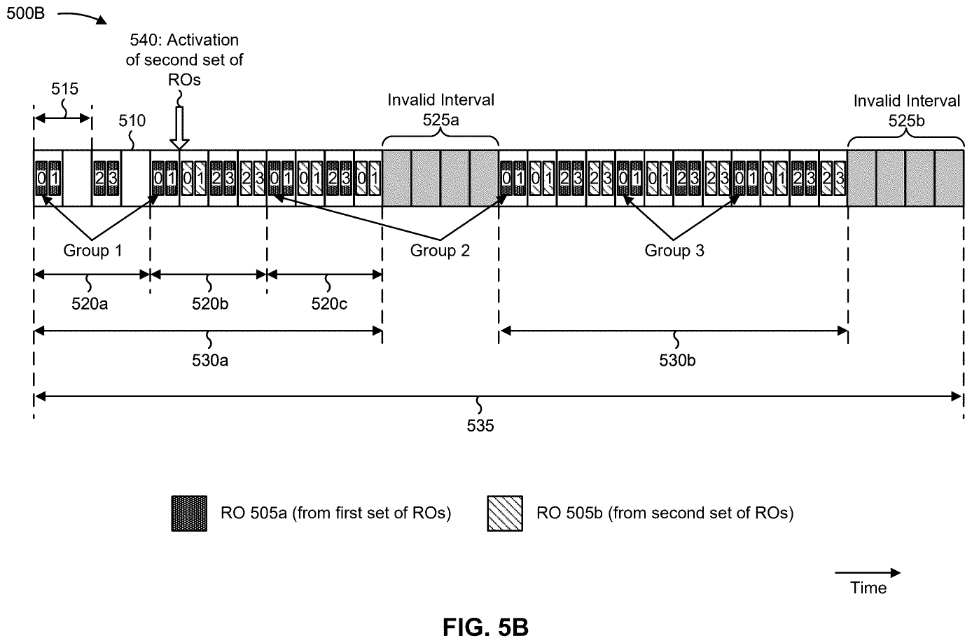

Various aspects relate generally to dynamic adaptation in the formation of RO groups. Some aspects more specifically relate to the UE forming RO groups that include dynamically activated ROs in accordance with one or more RO grouping rules. For example, the UE may select a starting time to begin forming RO groups that include the dynamically activated ROs in accordance with the one or more RO grouping rules. In some examples, the UE may start forming the RO groups as soon as the dynamically activated ROs are activated. In some examples, the UE may start forming the RO groups at a start of a next association pattern period (e.g., where the association pattern period is described with reference to FIG. 5). In some examples, the UE may start forming the RO groups after a current RO group pattern (e.g., where the RO group pattern is described with reference to FIG. 5). Additionally, the one or more rules may indicate whether the UE forms joint-RO groups or independent RO groups. In some examples, the one or more RO grouping rules may indicate separate rules associated with RO group patterns for respective UEs associated with separate capabilities (e.g., a first RO group pattern formation for UEs of a first capability and a second RO group pattern formation for UEs of a second capability). In some other examples, the one or more RO grouping rules may indicate rules associated with RO group patterns independent of UE capabilities (e.g., a single RO group pattern formation for UEs of the first capability and a second RO group pattern formation for UEs of the second capability). In some examples, the network node may transmit, and the UE may receive, control information that indicates the one or more RO grouping rules. In some examples, the one or more RO grouping rules may be at least partially defined in a wireless communications standard.

Particular aspects of the subject matter described in this disclosure can be implemented to realize one or more of the following potential advantages. In some examples, the described techniques can be used to increase the efficiency of RACH procedures. For example, by forming RO groups that include dynamically activated ROS, the UE may be able to form RO groups that are earlier in time, which may reduce latency associated with transmitting repetitions of a PRACH preamble. Additionally, the one or more RO grouping rules may reduce a number of valid ROs skipped by the UE, which may increase utilization of resources for wireless communications. In some aspects, the described techniques can be used to reduce miscommunication between the network node and UEs associated with different capabilities. For example, based on the one or more RO grouping rules specifying RO group patterns in accordance with a dynamically activated capability, the network node may better handle RACH procedures for UEs of varying capabilities.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, NES, low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

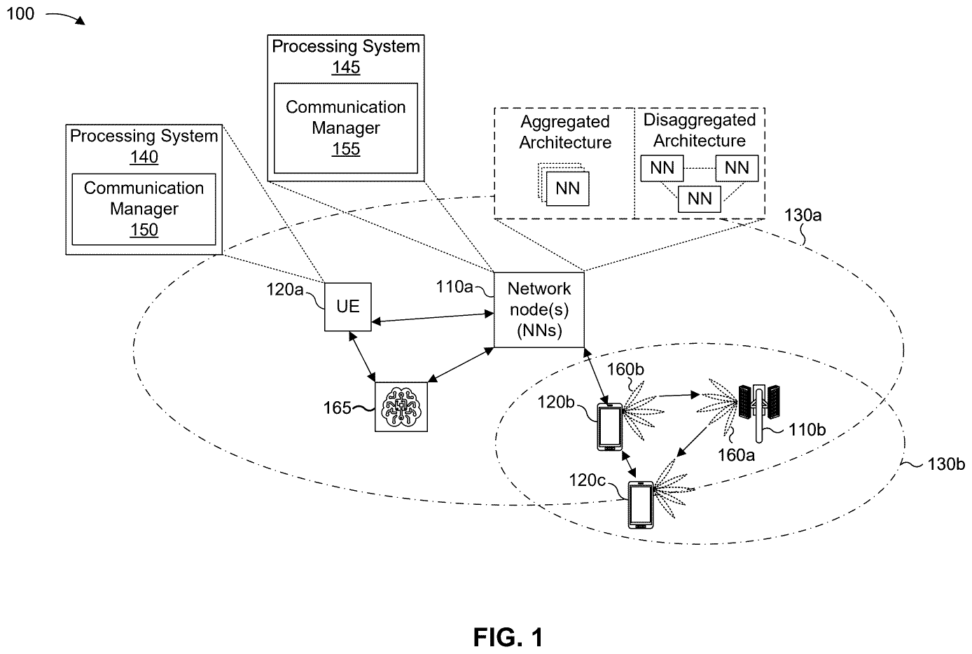

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHz), FR4a or FR4-1 (52.6 GHz through 71 GHZ), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz, through 300 GHZ), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ.” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHZ.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry.”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

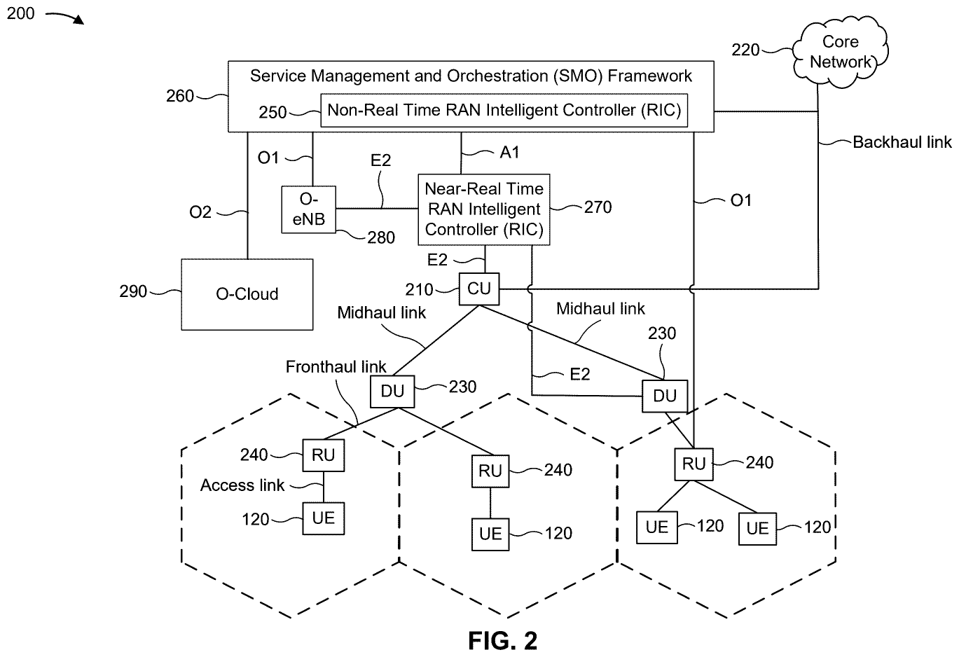

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUS). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the number of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) number of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may transmit, to a network node, one or more first repetitions of a PRACH preamble during one or more first RO groups, wherein the one or more first RO groups include a first set of ROs that are mapped to a SSB; receive, from the network node, control information that activates a second set of ROs, wherein the second set of ROs are mapped to the SSB; and transmit, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules. Additionally, or alternatively, the communication manager 150 may perform one or more other operations described herein.

In some aspects, the network node may include a communication manager 155. As described in more detail elsewhere herein, the communication manager 155 may receive, from a UE, one or more first repetitions of a PRACH preamble during one or more first RO groups, wherein the one or more first RO groups include a first set of ROs that are mapped to a SSB; transmit, to the UE, control information that activates a second set of ROs, wherein the second set of ROs are mapped to the SSB; and receive, from the UE after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

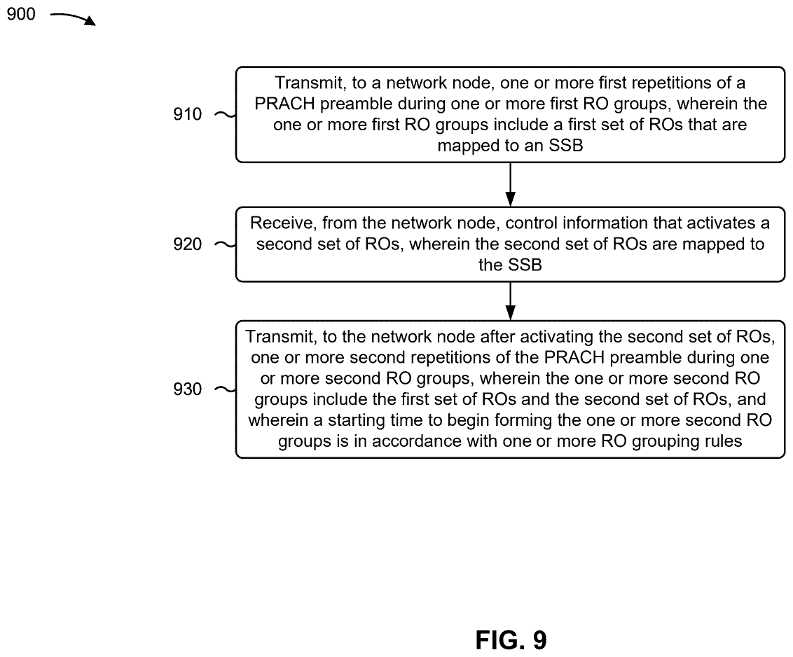

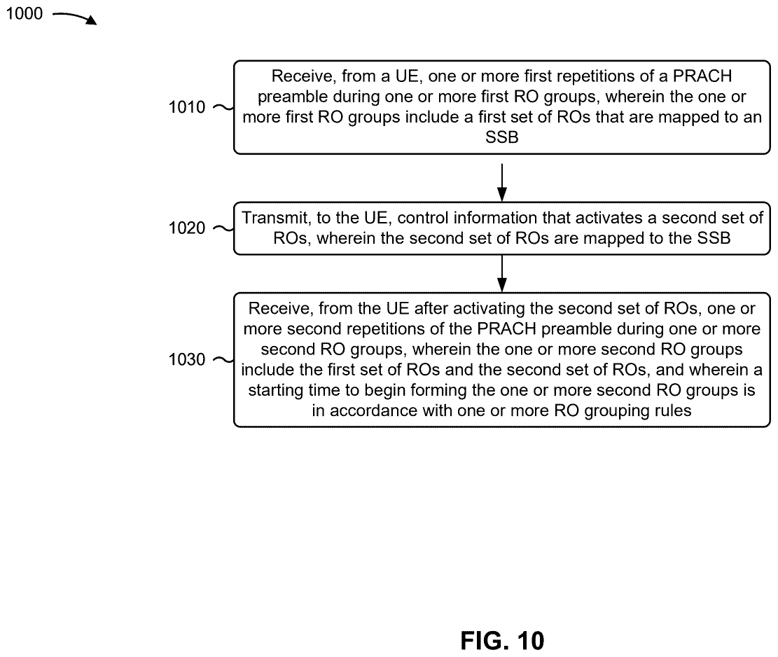

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with dynamic adaptation of PRACH transmissions, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

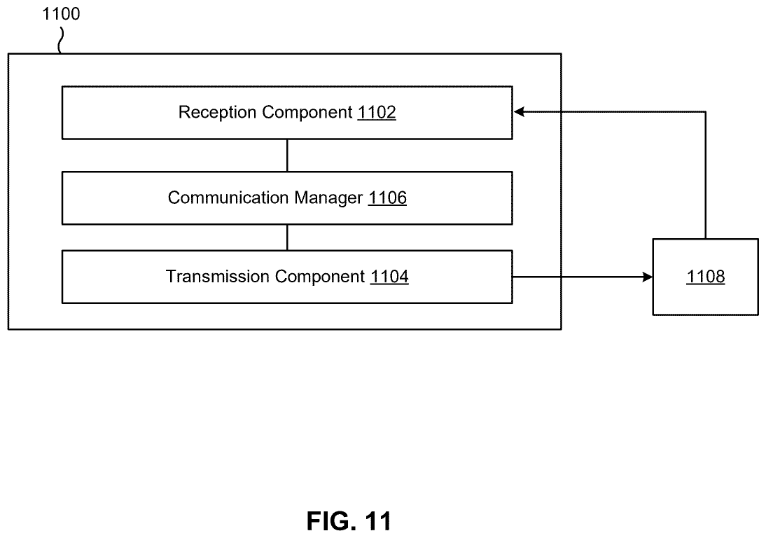

In some aspects, an UE includes means for transmitting, to a network node, one or more first repetitions of a PRACH preamble during one or more first RO groups, wherein the one or more first RO groups include a first set of ROs that are mapped to a SSB; means for receiving, from the network node, control information that activates a second set of ROs, wherein the second set of ROs are mapped to the SSB; and/or means for transmitting, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

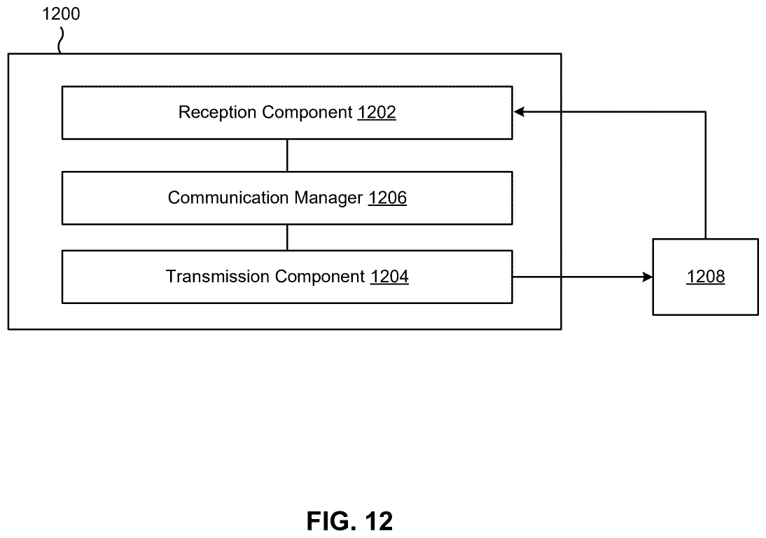

In some aspects, a network node includes means for receiving, from a UE, one or more first repetitions of a PRACH preamble during one or more first RO groups, wherein the one or more first RO groups include a first set of ROs that are mapped to a SSB; means for transmitting, to the UE, control information that activates a second set of ROs, wherein the second set of ROs are mapped to the SSB; and/or means for receiving, from the UE after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules. The means for the network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

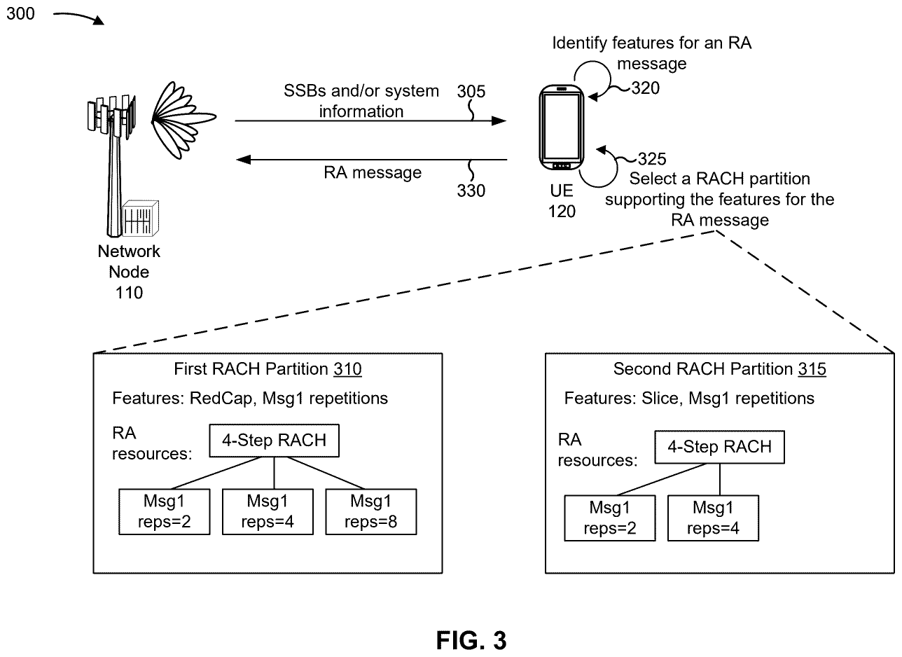

FIG. 3 is a diagram illustrating an example 300 of selection of a number of repetitions for transmitting a random access (RA) message, in accordance with the present disclosure.

Random access procedures between a UE 120 and a network node 110 may enable the UE 120 and the network node 110 to establish initial communication links, recover lost connections, and/or perform tasks, such as beam failure recovery, among other examples. A random access procedure may be performed to enable the UE 120 to gain synchronization (e.g., time domain synchronization and/or frequency domain synchronization) with the network node 110. The configuration of random access procedures may be indicated via system information signaling from the network node 110, which specify the resources and timing for one or more RACH occasions. A random access procedure may include the transmission of a preamble by the UE 120, reception of a random access response from the network node 110 by the UE 120, potentially further signaling for contention resolution, and a resource allocation for uplink communication. The UE 120 and the network node 110 performing the random access procedure may enable efficient utilization of network resources while accommodating multiple UEs 120 in a synchronized manner, thus maintaining the integrity and performance of the wireless communication system.

A random access procedure may include a two-step random access procedure, a four-step random access procedure, and/or another type of random access procedure. The random access procedure may be a contention-based random access procedure (e.g., where a set of random access resources is configured for multiple UEs 120 and each UE 120 may select a random access resource (such as a preamble) from the set of random access resources for performing a random access procedure) or a contention-free random access procedure (e.g., where the network node 110 configures random access resources specifically for a given UE 120).

As shown in FIG. 3, and by reference number 305, a network node 110 may transmit SSBs and/or system information. For example, the network node 110 may broadcast system information via a system information block (SIB), a master information block (MIB), and/or one or more SSBs, among other examples. The system information may include a random access configuration. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure or a four-step random access procedure. The random access configuration may indicate one or more random access resources, such as one or more preambles, and/or one or more RACH occasions, among other examples. The preamble may sometimes be referred to as a random access preamble, a PRACH preamble, or a random access message preamble, among other examples. The one or more RACH occasions may indicate time domain resources and/or frequency domain resources, among other examples, that are available for the UE 120 to transmit a random access message, such as a random access message that includes a preamble.

The random access configuration may indicate one or more partitions of random access resources (e.g., one or more RACH partitions). As used herein, “random access resource” refers to one or more resources used, configured, and/or allocated for performing a random access procedure. A random access resource may include a RACH occasion (e.g., one or more time-frequency resources, spatial domain resources, and/or code domain resources allocated and/or configured for a UE 120 to transmit an RA message), and/or a preamble (e.g., a preamble index), among other examples. A RACH occasion may also be referred to herein as a random access transmission opportunity, and/or a PRACH occasion, among other examples. As used herein, a “partition” of random access resources refers to a subset of random access resources from a set of random access resources configured or available for performing a random access procedure. For example, a network node 110 may group (e.g., partition) a subset of random access resources for different device capabilities and/or features. By a UE 120 using a random access resource configured in a given partition, the network node 110 may identify that the UE 120 supports a feature and/or device capability associated with the given partition.

For example, a partition may be indicated or configured via a feature combination parameter in a RACH configuration. The feature combination parameter may be a featureCombinationPreambleList-r17 parameter. The RACH configuration may be a common RACH configuration (e.g., a rach-ConfigCommon) or an additional RACH configuration (e.g., an AdditionalRACH-ConfigList-r17). The feature combination parameter may indicate one or more features associated with the partition (e.g., via a featureCombination-r17 parameter). The feature combination parameter may indicate one or more preambles (e.g., one or more preamble indices) included in the partition (e.g., via a starting preamble parameter (a startPreambleForThisPartition-r17 parameter) and a number of preambles for each SSB parameter (e.g., a numberOfPreamblesPerSSB-ForThisPartition-r17 parameter)). Repetitions of a random access message may be considered a feature, as indicated by the featureCombination-r17 parameter. Different repetition numbers may be considered or treated as different RACH types. For example, different repetition numbers may have random access resources configured via separate partitions (e.g., via separate featureCombinationPreambles-r17 parameters). Random access resources that are configured with the same feature (e.g., the same featureCombination-r17 parameter) may be considered to be within the same set of random access resources. In some examples, for a partitions associated with multiple numbers of repetitions, one or parameters (e.g., defined via a rach-ConfigGeneric parameter) may be common for the multiple numbers of repetitions. For example, a deltaPreamble information element (IE) in a FeatureCombinationPreambles IE may be common for repetition number 2, 4 and 8. The numberOfRA-PreamblesGroupA parameter can be configured separately for different repetition numbers. The same value of a target receive power parameter(s) (e.g., a preambleReceiveTargetPower parameter and/or a powerRampingStep parameter) can be applied for different repetition numbers.

As shown in FIG. 3, a first RACH partition 310 may be associated with one or more features, such as RedCap support and repetitions of an RA message, such as a msg1 RA message (e.g., a random access message payload, a first message, an initial message, and/or an RA message that includes a preamble). The first RACH partition 310 may be associated with a set of candidate RACH resources for four-step RACH, with the set of candidate RACH resources supporting msg1 with 2 repetitions (reps=2), with 4 repetitions (reps=4), or with 8 repetitions (reps=8). The different numbers of repetitions may be treated as different RACH types within the same feature (e.g., support for multiple repetitions).

As shown in FIG. 3, a second RACH partition 315 may be associated with features, such as slice support and msg1 repetitions. The second RACH partition 315 may be associated with a set of candidate RACH resources for four-step RACH, with the set of candidate RACH resources supporting msg1 with 2 repetitions reps=2 or with 4 repetitions.

At 320, the UE 120 may identify features for an RA message (e.g., a first RA message). For example, the UE 120 may identify one or more features that the UE 120 desires to use for transmitting the RA message, such as RedCap support, slice support, and/or repetition support for the first RA message, among other examples.

At 325, the UE 120 may select a RACH partition supporting the features for the RA message. For example, the UE 120 may select the RACH partition from a set of candidate RACH partitions, with the selection based at least in part on matching the features desired for a RACH procedure with the RACH partition.

At 330, the UE 120 may transmit the RA message using RACH resources from the selected RACH partition. For example, the UE 120 may transmit the RA message using RACH resources associated with 2 repetitions as an initial attempt for transmission of the RA message. In some networks, based at least in part on the initial attempt for transmission of the RA message failing (e.g., as identified by failing to receive an RAR in response to the first RA message), the UE 120 may select a different resource within the selected RACH partition to increase a number of repetitions.

The network node 110 may identify the feature(s) for the RA message based on the random access resource(s) used to transmit the RA message. For example, if the random access resource(s) are included in the first partition 310 and configured for four repetitions, then the network node 110 may identify that the UE 120 is a RedCap type of UE 120 and is going to transmit four repetitions of the RA message. As another example, if the random access resource(s) are included in the second partition 315 and configured for two repetitions, then the network node 110 may identify that the UE 120 is using slice support for the RA message and is going to transmit two repetitions of the RA message. This enables the network node 110 to identify features and/or a number of repetitions for RA messages without explicit indications or signaling from the UE 120. This enables the network node 110 to efficiently and correctly process (e.g., combine repetitions) the RA message(s) transmitted by the UE 120.

As indicated above. FIG. 3 is provided as an example. Other examples may differ from what is described with regard to FIG. 3.

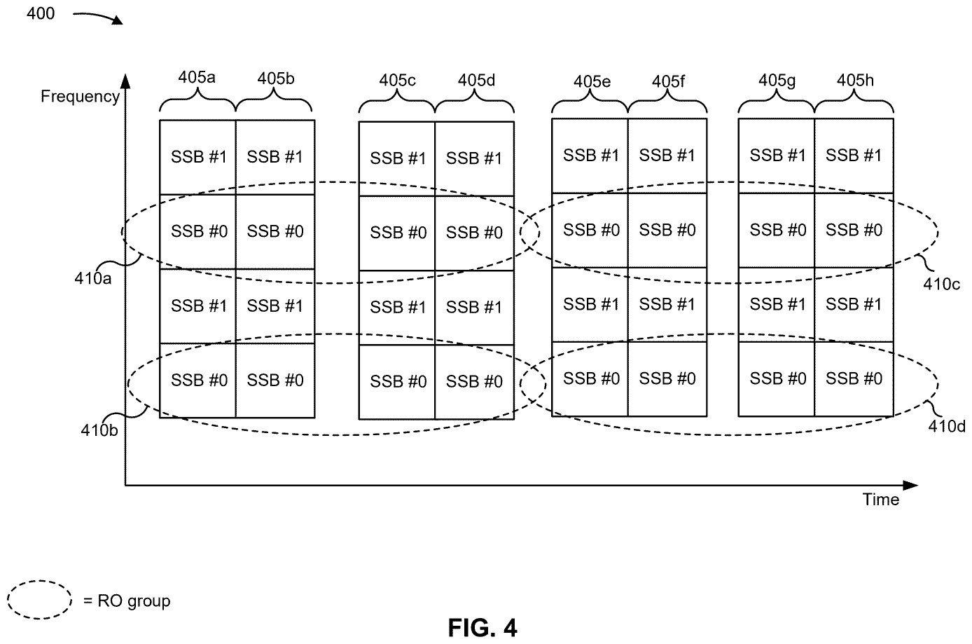

FIG. 4 is a diagram illustrating an example 400 of RACH occasion groups, in accordance with the present disclosure.

As shown in FIG. 4, multiple RO groups may be defined in a frequency domain and in a time domain. An RO group may be associated with a periodic pattern. The RO group may include a first starting RO. The RO group may be a set of

$${N}_{preamble}^{rep}$$

valid ROs, or PRACH occasions, that are consecutive in time and use the same frequency resources. When a number of repetitions for an RA message (e.g., as indicated by an

$${N}_{preamble}^{rep}$$

parameter) is four PRACH repetitions, two SSBs (e.g., SSB #0 and SSB #1) may be used as shown in FIG. 4 as an example. Each RO may have four frequency division multiplexed ROs (across RO groups), and an RO group may have four valid ROs. For other numbers of repetitions (e.g., two, eight, or another number), a different number of SSBs may be used and/or each RO group may include a different number of ROs.

For example, as shown in FIG. 4, a network node 110 may configure SSB indices to be associated with respective time domain occasions 405 (shown in FIG. 4 as time domain occasions 405a, 405b, 405c, 405d, 405c, 405f, 405g, and 405h). The time domain occasion 405 and a frequency domain occasion associated with a given SSB index may be configured as an RO. As shown in FIG. 4, one or more RO groups 410 may be formed. In the example shown in FIG. 4, each RO group 410 (e.g., RO group 410a, RO group 410b, RO group 410c, and RO group 410d) may include two or more ROs (e.g., four ROs as shown in FIG. 4). An RO group may also be referred to as a set of valid ROs. When a UE 120 transmits repetitions of an RA message, such as a Msg1, the UE 120 may transmit the repetitions via respective ROs included in a given RO group 410. This enables the network node 110 to identify the ROs in which repetitions of a given RA message are to be transmitted by the UE 120, thereby enabling the network node 110 to efficiently and accurately combine the repetitions of the RA message for improved performance of the RA message (e.g., improved likelihood of correct decoding and/or detection of the RA message).

In some examples, the UE 120 may determine the RO groups 410 based on configuration information received from the network node 110. For example, ROs may be mapped consecutively per corresponding SSB index. The UE 120 may determine the SSB-RO mapping based on identifying valid ROs. The UE 120 may determine whether an RO is valid. For example, from a physical layer perspective at a UE 120, a four-step RACH procedure, also known as a Type-1 random access procedure, includes transmission of a random access preamble (Msg1) in a valid RO (sometimes called a PRACH occasion), reception of a random access response (RAR) message with a PDCCH/PDSCH (Msg2), and when applicable, transmission of a PUSCH scheduled by an uplink grant in the RAR (Msg3) and reception of a PDSCH for contention resolution (Msg4). Additionally, or alternatively, in a two-step RACH procedure, also known as a Type-2 random access procedure, a UE 120 transmits a random access preamble in a valid RO and transmits a PUSCH payload (collectively referred to as MsgA) and the UE 120 then receives a RAR message with a PDCCH/PDSCH (MsgB). Furthermore, when applicable, the UE 120 transmits a PUSCH scheduled by a fallback uplink grant in the RAR and receives a PDSCH for contention resolution. In either case, when a RACH procedure is triggered (e.g., by higher layers at the UE 120 and/or by a PDCCH order message received from a network node 110), the UE 120 may determine an RO (e.g., corresponding to time and frequency resources for a PRACH transmission) in which to transmit the random access preamble, also known as a PRACH, according to an SSB-RO mapping.

For example, prior to initiation of a RACH procedure or transmission of a PRACH, a network node 110 may provide a UE 120 with random access configuration information that indicates PRACH transmission parameters (e.g., a PRACH preamble format, time/frequency resources for PRACH transmission, a preamble index, and/or a preamble SCS, among other examples). Furthermore, the UE 120 may receive an indication of one or more SSB indexes in an ssb-PositionsInBurst parameter (e.g., indicated in a SIB type 1 (SIB1) and/or a ServingCellConfigCommon parameter) that are mapped to valid ROs. For example, the SSB indexes indicated in the ssb-PositionsInBurst parameter are mapped to valid ROs in an increasing order of preamble indexes within a single RO, then in an increasing order of frequency resource indexes for frequency multiplexed ROs, then in an increasing order of time resource indexes for time multiplexed ROs within a PRACH slot, and then in an increasing order of indexes for PRACH slots. In this way, when a PRACH transmission is triggered at the UE 120, the UE 120 may transmit a PRACH preamble in a valid RO that is mapped to an SSB index (e.g., an SSB index indicated in a PDCCH order triggering the PRACH transmission or an SSB index selected by the UE 120). Accordingly, because the UE 120 transmits the PRACH preamble in a valid RO that is mapped to or otherwise associated with an SSB index, the UE 120 may apply one or more validation rules to determine whether an RO is valid or invalid. For example, in paired spectrum or a supplementary uplink band, all ROs are valid. However, for unpaired spectrum (e.g., a time division duplexing (TDD) band), an RO must satisfy one or more validation rules to be considered valid.

For example, the validation rules that are applied to determine whether an RO is valid or invalid may depend on whether a UE 120 has been provided with a parameter that indicates an uplink and downlink TDD configuration, or TDD pattern. For example, the uplink and downlink TDD configuration may be indicated in a tdd-UL-DL-ConfigurationCommon parameter, and may include a periodicity of a TDD pattern, a number of consecutive full downlink slots that begin each TDD pattern, a number of consecutive downlink symbols in the beginning of a slot that follows a last full downlink slot, a number of consecutive full uplink slots that end each TDD pattern, and a number of consecutive uplink symbols in the end of a slot that precedes a first full uplink slot. Accordingly, as described herein, the UE 120 may apply a first set of validation rules to determine whether an RO is valid in cases where the uplink and downlink TDD configuration has not been provided, and may apply a second set of validation rules to determine whether an RO is valid in cases where the uplink and downlink TDD configuration has been provided.

For example, if the UE 120 has not been provided with an uplink and downlink TDD configuration, an RO in a PRACH slot is valid if the RO does not precede an SSB in the PRACH slot and starts at least N_{gap} symbols after a last SSB reception symbol, where N_{gap} may have a value that depends on a preamble SCS (e.g., N_{gap} may have a value of 0 for a preamble SCS of 1.25 kilohertz (kHz) or 5 kHz, 2 for a preamble SCS of 15 kHz, 30 kHz, 60 kHz, or 120 kHz, 8 for a preamble SCS of 480 kHz, or 16 for a preamble SCS of 960 kHz). Furthermore, in cases where a semi-static channel access mode is configured, a valid RO cannot overlap with a set of consecutive symbols before the start of a next channel occupancy time where the UE 120 does not transmit. Otherwise, an RO that fails to satisfy the applicable validation rules is considered invalid for SSB-RO mapping purposes and for PRACH transmission. For example, an RO may be invalid because the RO precedes an SSB in the PRACH slot. Furthermore, an RO may be invalid because the RO is fewer than N_{gap} symbols after a last SSB reception symbol. On the other hand, an RO that does not precede an SSB in a PRACH slot and is at least N_{gap} symbols after a last SSB reception symbol is considered valid.

Additionally, or alternatively, if the UE 120 has been provided with an uplink and downlink TDD configuration, an RO is valid if the RO is within uplink symbols. For example, an RO may be valid because the RO is within uplink symbols. Alternatively, if an RO is not within uplink symbols (e.g., is within downlink or flexible symbols), then the RO is valid only if the RO does not precede an SSB in a PRACH slot and starts at least N_{gap} symbols after a last downlink symbol and least N_{gap} symbols after a last SSB symbol, where N_{gap} may have a value that depends on a preamble SCS. Furthermore, in cases where a semi-static channel access mode is configured, a valid RO cannot overlap with a set of consecutive symbols before the start of a next channel occupancy time where no transmissions are permitted. Otherwise, an RO that fails to satisfy the applicable validation rules is considered invalid for SSB-RO mapping purposes and for PRACH transmission. For example, an RO may be invalid because the RO precedes an SSB in the PRACH slot. Furthermore, an RO may be invalid because the RO is fewer than N_{gap} symbols after a last downlink symbol and fewer than N_{gap} symbols after a last SSB symbol. On the other hand, an RO that does not precede an SSB in a PRACH slot and is at least N_{gap} symbols after a last downlink symbol and a last SSB reception symbol is considered valid.

The indexing of the PRACH occasion indicated by a mask index value may be reset per mapping cycle of consecutive PRACH occasions per SSB index. The UE 120 may select, for a transmission of an RA message (e.g., a PRACH transmission), an RO indicated by a PRACH mask index value for the indicated SSB index in the first available mapping cycle. For a given preamble index, the ordering of ROs may be: first, in increasing order of frequency resource indices for frequency multiplexed ROs; second, in increasing order of time resource indexes for time multiplexed ROs within a PRACH time interval (e.g., a PRACH slot); and third, in increasing order of indexes for PRACH slot.

For a PRACH transmission with

$${N}_{preamble}^{rep}$$

preamble repetitions, a set consists of

$${N}_{preamble}^{rep}$$

valid ROs that are consecutive in time, use same frequency resources, and are associated with same one or more SSB index(es). For example, if the

$${N}_{preamble}^{rep}$$

parameter indicates four repetitions, then the set of valid ROs may include four ROs. Each SSB index may be associated with same preamble indexes in all valid ROs within the set. The set of valid ROs may form an RO group 410.

For a transmission of an RA message (e.g., a PRACH transmission) with preamble repetitions, a time period, starting from a frame 0, may be the smallest integer number of association pattern periods such that at least one set of valid PRACH occasions for each of the SSB indices can be determined within the time period for all configured number of preamble repetitions. The set(s) of valid PRACH occasions for each configured number of preamble repetitions may repeat every time period.

Within a time period, for set(s) of

$${N}_{preamble}^{rep}$$

valid ROs for a PRACH transmission with

$${N}_{preamble}^{rep}$$

preamble repetitions (e.g., for a given RO group 410), the first valid RO of the first set may be the first valid RO. The first valid RO of subsequent sets, if any, may be determined according to an ordering of valid ROs: first, in increasing order of frequency resource indexes for frequency multiplexed ROs; second, in increasing order of time resource indexes for time multiplexed ROs. For each frequency resource index for frequency multiplexed ROs, the first valid RO of the first set is the first valid RO, and the first valid PRACH occasion of subsequent sets, if any, is: after a number of consecutive valid ROs (e.g., indicated by a msg1-Repetition Time OffsetROGroup parameter) in time from the first valid RO of the previous set, where each RO is associated with same SSB index(es) and SSB index is associated with same preambles, if the msg1-Repetition Time OffsetROGroup parameter is provided; or is after the ROs for the previous set, if the msg1-RepetitionTimeOffsetROGroup parameter is not provided.

As indicated above, FIG. 4 is provided as an example. Other examples may differ from what is described with respect to FIG. 4.

FIGS. 5A and 5B are diagrams illustrating respective examples 500A and 500B of RACH occasion group formation, in accordance with the present disclosure. In some examples, FIGS. 5A and 5B may implement or be implemented by one or more aspects of FIGS. 1 through 4. For example, ROs 505 may be examples of ROs and/or PRACH occasions as described in FIGS. 3 and 4. Additionally, FIGS. 5A and 5B may describe an RO group 1, an RO group 2, and an RO group 3, which may be respective examples of RO groups 410 (e.g., corresponding to SSB #0), as described with reference to FIG. 4.

In some examples, the network node 110 may configure the UE 120 with the ROs 505 via system information signaling (e.g., including SIB signaling and/or MIB signaling). In some other example, the network node 110 may configure the UE 120 with the ROs 505 via other types of signaling, including one or more of RRC signaling, MAC signaling (such as a MAC-CE), or DCI signaling. Additionally, or alternatively, the network node 110 may transmit, and the UE 120 may receive, control signaling (e.g., RRC signaling, MAC signaling, or DCI signaling) that is indicative of a set of PRACH parameters associated with the PRACH configuration. For example, the control signaling may indicate a PRACH configuration index from a set of PRACH configuration indexes, where the PRACH configuration index indicates and/or is associated with the set of PRACH parameters. In some examples, the set of PRACH configuration indexes may be defined in a wireless communication standard. In some examples, the control signaling may explicitly indicate one or more of the set of PRACH parameters. With reference to FIGS. 5A and 5B, the set of PRACH parameters may indicate information associated with one or more of a set of frames 510, a PRACH configuration period 515, one or more association periods 520, one or more association pattern periods 530, and one or more RO group patterns 535.

Examples 500A and 500B illustrate the set of consecutive frames 510 in time (e.g., 32 frames) during which the network node 110 schedules the ROs 505. In some examples, the ROs may be scheduled in even numbered frames (e.g., 0, 2, etc.) in accordance with the PRACH configuration period 515. For instance, the PRACH configuration period 515 may be a configured duration (e.g., 20 ms) as indicated in the set of PRACH parameters. In some examples, the set of PRACH parameters may indicate a number of PRACH slots per frame (e.g., two PRACH slots per frame in examples 500A and 500B). In some examples, the set or PRACH parameters may indicate a number of ROs 505 allowed per PRACH slot (e.g., one RO 505 per PRACH slot in example 500A and 500B) and a number of SSBs allowed for association with each RO 505 (e.g., one SSB per RO 505 in examples 500A and 500B). Therefore, in examples 500A and 500B, each of the even numbered frames 510 may include up to two ROs 505, where each RO 505 is associated with up to one SSB.

As described with reference to FIG. 4, the network node 110 may transmit, and the UE 120 may receive, an indication of one or more SSB indexes, in an ssb-PositionsInBurst parameter (e.g., indicated in a SIB1 and/or a ServingCellConfigCommon parameter) that are mapped to valid ROs 505. For instance, in examples 500A and 500B the network node 110 may indicate a set of four SSB indexes (e.g., SSB0, SSB1, SSB2, and SSB3). As illustrated in FIGS. 5A and 5B, the set of four SSB indexes are mapped to the ROs 505.

In some examples, the association period 520 is associated with the minimum number of PRACH configuration periods 515 that include a sufficient number of ROs 505 to allow every SSB index of the set of SSB indexes to be mapped onto the set of ROs (e.g., in accordance with the SSB-to-RO mapping described with reference to FIG. 4). In some examples, the UE 120 determines the duration of the association period 520 in accordance with Table 1.

TABLE 1

| PRACH configuration | Number of PRACH configuration periods per |
|---|---|
| period duration (ms) | association period |
| 10 | {1, 2, 4, 8, 16} |
| 20 | {1, 2, 4, 8} |
| 40 | {1, 2, 4} |
| 80 | {1, 2} |
| 160 | {1} |

In accordance with Table 1, the number of PRACH configuration periods 515 allowed for the association period 520 may be based on the duration of the PRACH configuration period 515. With reference to examples 500A and 500B, the duration of the PRACH configuration periods 515 is 20 ms; therefore, the number of PRACH configuration periods 515 allowed for the association period 520 is one of {1, 2, 4, 8}. Because the UE 120 can map each of SSB0, SSB1, SSB2, and SSB3 to a respective RO 505 in two PRACH configuration periods 515, the number of PRACH configuration periods 515 included in the association period 520 is 2 (e.g., in accordance with the value 2 being included in {1, 2, 4, 8}). However, if in another example, the UE 120 can map each of SSB0, SSB1, SSB2, and SSB3 to a respective RO 505 in three PRACH configuration periods 515, the number of PRACH configuration periods 515 included in the association period 520 is 4 (e.g., in accordance with the value 4 being included in {1, 2, 4, 8}).

The association pattern period 530 may include a number of association periods 520. In some examples, the UE 120 may determine the number of association periods 520 such that a pattern between the ROs 505 and the SSB indexes repeats in accordance with a configured periodicity (e.g., repeats at most every 160 ms or every 16 frames, with reference to examples 500A and 500B). As described with reference to FIG. 4, ROs 505 not associated with the set of SSB indexes after an integer number of association periods 520, if any, are not used for PRACH transmissions. Additionally, examples 500A and 500B illustrate invalid intervals 525 (e.g., invalid intervals 525a and 525b). In some examples, the invalid intervals 525 may be associated with an association pattern 520 that includes ROs 505 that are invalid. For instance, a given RO 505 may be invalid in accordance with the one or more validation rules, as described with reference to FIG. 4 (such as interference with an SSB). Therefore, in examples 500A and 500B, a given association pattern period 530 may include three association periods 520 (e.g., an association pattern period 530a includes association periods 520a, 520b, and 520c).

Additionally, the set or PRACH parameters may indicate or be associated with a number of PRACH repetitions and a number of RO groups. For example, as described with reference to FIG. 4, a number of PRACH repetitions for an RA message may be indicated by an

$${N}_{preamble}^{rep}$$

parameter, where each RO group may include a number of valid ROs 505 as indicated by the

$${N}_{preamble}^{rep}$$

parameter, and where each RO group may be associated with one or more SSB indexes. With reference to examples 500A and 500B, the

$${N}_{preamble}^{rep}$$

parameter may be two (e.g., two ROs 505 per RO group) and each of the RO groups may be associated with SSB0, in the example 500A and 500B.

The RO group pattern 535 may be a periodic pattern with a period associated with a number of association pattern periods 530 (e.g., K SSB-to-RO association pattern periods). For example, the value of K may be a minimum number of association pattern periods 530 in which there is at least one RO group for each of the configured PRACH repetition numbers. For instance, each association pattern period 530 may include three ROs 505 that are mapped to SSB0, and because the number of ROs 505 per RO group is two, the RO group pattern may include two consecutive association pattern periods 530 such that six ROs 505 that are mapped to SSB0 may be formed into three RO groups. That is, the first and second ROs 505 that are mapped to SSB0 in association pattern period 530a may be included in RO group 1, the third RO 505 mapped to SSB0 in association pattern period 530a and the first RO 505 mapped to SSB0 in association pattern period 530b may be included in RO group 2, and the second and third ROs 505 that are mapped to SSB0 in association pattern period 530b may be included in RO group 3. Therefore, each RO 505 that is mapped to SSB0 in the RO group pattern 535 may be included in an RO group.

FIG. 5A is a diagram illustrating an example 500A of a RACH occasion group formation associated with a single set of RACH occasions, in accordance with the present disclosure.

For example, as illustrated in FIG. 5A, the set of frames 510 are associated with ROs 505a, where the ROs 505a may be included in a first set of ROs. In some examples, the network node 110 may transmit, and the UE 120 may receive, control signaling that indicates and/or configures the ROs 505a. For example, the control signaling may be RRC signaling (e.g., via one or more RRC connection reconfiguration messages). In some examples, the control signaling that indicates and/or configures the ROs 505a may include the PRACH configuration index that indicates and/or is associated with the set of PRACH parameters. In some examples, the control signaling may additionally activate the ROs 505a for use by the UE 120. In some other examples, the network node 110 may transmit, and the UE 120 may receive, second control signaling that dynamically activates the ROs 505a for use by the UE 120 (e.g., MAC-CE signaling or DCI signaling).

Therefore, in accordance with example 500A, the UE 120 may perform the SSB-to-RO mapping and form RO groups in accordance with ROs 505a that are activated and valid.

FIG. 5B is a diagram illustrating an example 500B of a RACH occasion group formation associated with multiple sets of RACH occasions, in accordance with the present disclosure.

For example, as illustrated in FIG. 5B, the set of frames 510 are associated with the ROs 505a, where the ROs 505a may be configured, activated, and validated in accordance with the one or more aspects of example 500A. In example 500B, however, the UE 120 may be additionally associated with ROs 505b, which may be included in a second set of ROs (e.g., an additional set of ROs that is separate from the first set of ROs). In some examples, the ROs 505a and the ROs 505b may be associated with a single PRACH configuration. For example, control signaling (e.g., RRC signaling) may indicate a single PRACH configuration that indicates and/or configures the ROs 505a and the ROs 505b. In some other examples, the network node 110 and/or the UE 120 may support multiple PRACH configurations, where a first PRACH configuration includes the ROs 505a and a second PRACH configuration includes the ROs 505b. For example, the control signaling may indicate the first PRACH configuration associated with the ROs 505a and indicate the second PRACH configuration associated with the ROs 505b.

In some examples, the ROs 505a may be described as traditional ROs (e.g., legacy ROs). For example, traditional ROs may be associated with a broad compatibility and support for wireless devices regardless of whether the wireless devices support energy-saving features or enhanced random access capabilities (such as NES). In some examples, traditional ROs may be available across a wider range of time-frequency resources, compared to the ROs 505b, to support a broad spectrum of UEs 120. In some examples, the traditional ROs may not be associated with configurations for energy savings, such as reduced monitoring or transmission windows.

In some examples, the ROs 505b may be described as dynamically activated ROs. In one example, the ROs 505b may be NES ROs. For example, NES ROs may be associated with energy-efficient random access procedures, helping to reduce power consumption at both the UE 120 and network node 110. In some examples, NES ROs are typically more optimized, compared to the ROs 505a, in terms of timing and frequency to reduce UE 120 power consumption during the random access procedure. For instance, NES ROs may be associated with narrower resource configurations or shorter monitoring windows, compared to the ROs 505a, to save energy. In some examples, the network node 110 may selectively activate or deactivate (and/or dynamically activate or deactivate) NES ROs based on traffic patterns and/or energy-saving protocols associated with a wireless network. In some examples, UEs 120 of the first capability may operate in accordance with NES ROs. UEs 120 of the first capability may be UEs 120 capable of operating and/or enabled to operate in accordance with one or more NES protocols. For example, the one or more NES protocols may include one or more of dynamic resource allocation, enhanced discontinuous reception (DRX) cycles, energy-efficient RACH procedures, beam management, or adaptive cell and power control. In some examples, the NES protocols may be defined and/or associated with a wireless communications standard, such as 3GPP. In some examples, UEs 120 of the second capability (e.g., described as legacy UEs 120) may not operate in accordance with NES ROs. Non-NES-capable UEs 120 may be UEs 120 not capable of operating and/or not enabled to operate in accordance with the one or more NES protocols. While the ROs 505b being NES ROs is provided herein as an example, the ROs 505b may be associated with various types of capabilities associated with wireless communications.

Therefore, the ROs 505a (e.g., traditional ROs) are designed for universal compatibility and are less focused on energy efficiency, while the ROs 505b (e.g., dynamically activated ROs) are tailored to reduce energy consumption and support energy-saving devices or scenarios.

In some examples, there may be no time-domain overlap between the ROs 505a and the ROs 505b. In some examples, there may be time-domain overlap but no overlap in frequency domain between the ROs 505a and the ROs 505b. In some examples, there may be no time-domain overlap and no frequency-domain overlap between the ROs 505a and the ROs 505b. In some examples, there may be full or partial overlap in the time domain and the frequency domain between the ROs 505a and the ROs 505b.

In some examples, the SSB-to-RO mapping rules used to map SSB indexes to the ROs 505b may be the same SSB-to-RO mapping rules as used to map SSB indexes to the ROs 505a (e.g., the UE 120 maps both the ROs 505a and the ROs 505b in accordance with the same SSB-to-RO mapping rules described with reference to FIG. 4). In some examples, the one or more validation rules used for the ROs 505b may be the same one or more validation rules as used for the ROs 505a (e.g., the UE 120 uses the same validation rules to validate the ROs 505a and validate the ROs 505b in accordance with the one or more validation rules described with reference to FIG. 4).

As illustrated in FIG. 5B, the ROs 505b may be dynamically activated for use by the UE 120. For instance, in accordance with reference number 540, the network node 110 may activate the ROs 505b for use at the UE 120 at the beginning of the sixth frame 510. In some examples, the network node 110 may transmit, and the UE 120 may receive, dynamic signaling (e.g., MAC-CE signaling or DCI signaling) that activates the ROs 505b. In some examples, the ROs 505b may be activated directly after the UE 120 receives the dynamic signaling. In some examples, the dynamic signaling may indicate a time at which the ROs 505b are activated. For instance, in one example, the UE 120 may receive the dynamic signaling in the second frame 510, where the dynamic signaling indicates that the ROs 505b are activated at the start of the sixth frame 510.

In some examples, the UE 120 may perform SSB-to-RO mappings for the ROs 505a and the ROs 505b (e.g., based on there being no time-domain or frequency-domain overlap between ROs in example 500B). In some examples, the UE 120 may map the same SSB indexes to ROs 505a and the ROs 505b. For instance, as illustrated in FIG. 5B, the UE 120 performs a first SSB-to-RO mapping that maps SSB0, SSB1, SSB2, and SSB3 to the ROs 505a, and performs a second SSB-to-RO mapping that maps SSB0, SSB1, SSB2, and SSB3 to the ROs 505b. In some examples, the UE 120 may perform the first SSB-to-RO mapping and the second SSB-to-RO mapping concurrently. In some examples, the first SSB-to-RO mapping and the second SSB-to-RO mapping may partially overlap in time. In some examples, the UE 120 may perform the second SSB-to-RO mapping after completing the first SSB-to-RO mapping.

As illustrated in FIG. 5A, the RO group 1 is before activation of the ROs 505b, and RO group 2 and RO group 3 may be after activation of the ROs 505b. However, the UE 120 may be unaware of a time at which to start forming RO groups that include the ROs 505b, which may cause the UE 120 to skip one or more valid ROs 505b during RO group formation. By skipping one or more valid ROs, the UE 120 may reduce the efficiency of resource utilization and may increase the duration of RO group pattern 535, which may increase the latency associated with performing RACH procedures. Additionally, the UE 120 may be unaware of whether to form RO groups that include both ROs 505a and ROs 505b (e.g., joint-RO groups) or whether to form RO groups that exclusively include ROs 505a or exclusively include ROs 505b (e.g., independent RO groups). Therefore, the UE 120 may mismanage the formation of RO groups, which may result in miscommunication between the UE 120 and the network node 110. Additionally, UEs 120 of a first capability (e.g., NES-capable UEs 120, or another capability associated with wireless communications) may be able to use the ROs 505b, while UEs of a second capability (e.g., non-NES-capable UEs 120, or another capability associated with wireless communications) may be unable to use the ROs 505b, which means that UEs 120 associated with different capabilities may form RO groups in accordance with RO group patterns 535 of different durations (e.g., UEs 120 of the first capability may use an RO group pattern associated with a first value of K while UEs of the second capability may use an RO group pattern associated with a second value of K). Therefore, there may be discontinuity between RACH procedures for UEs 120 of different capabilities (such as different NES capabilities), which may increase complexity at the network node 110.

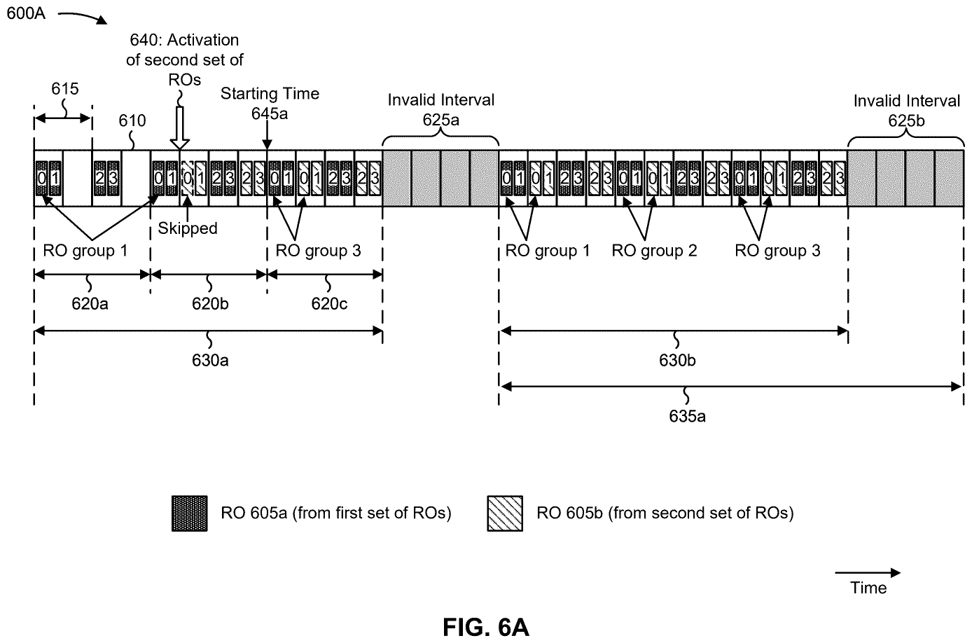

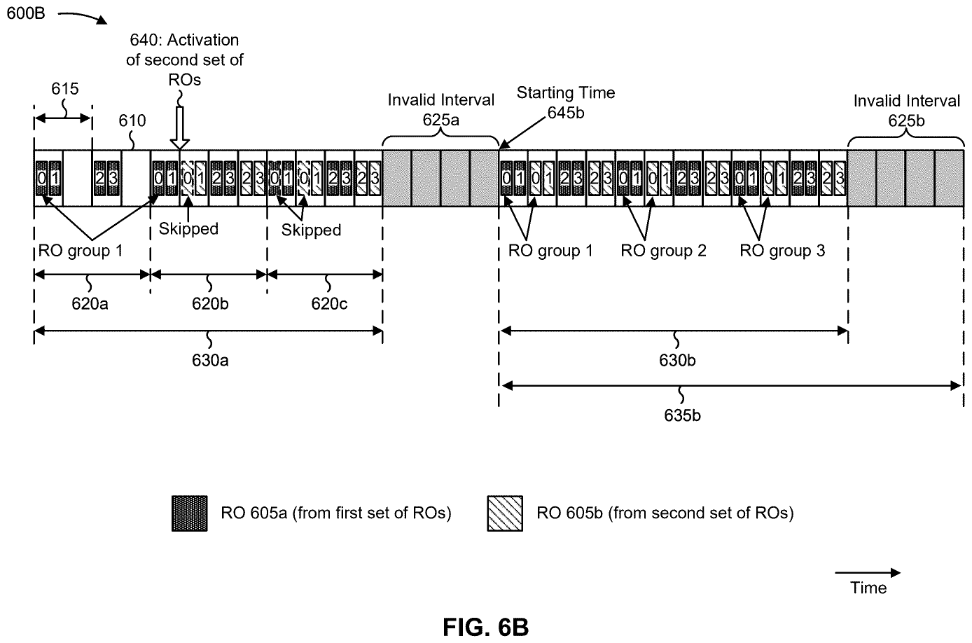

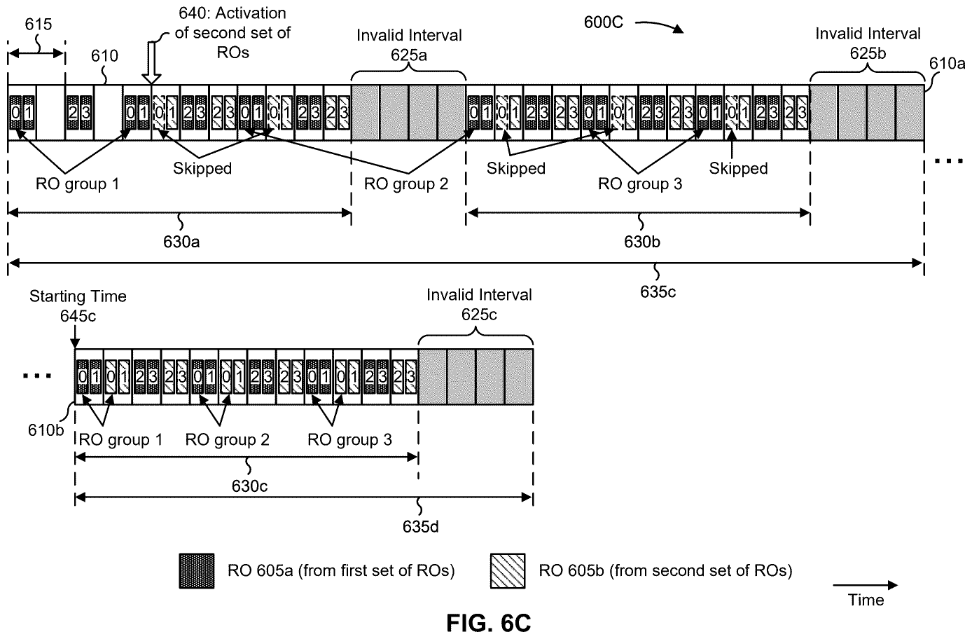

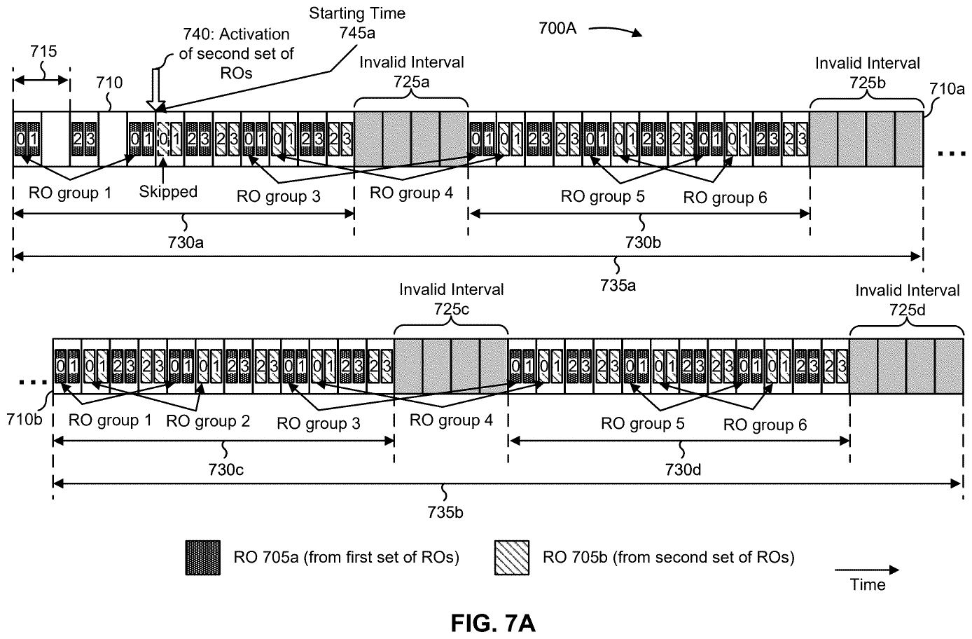

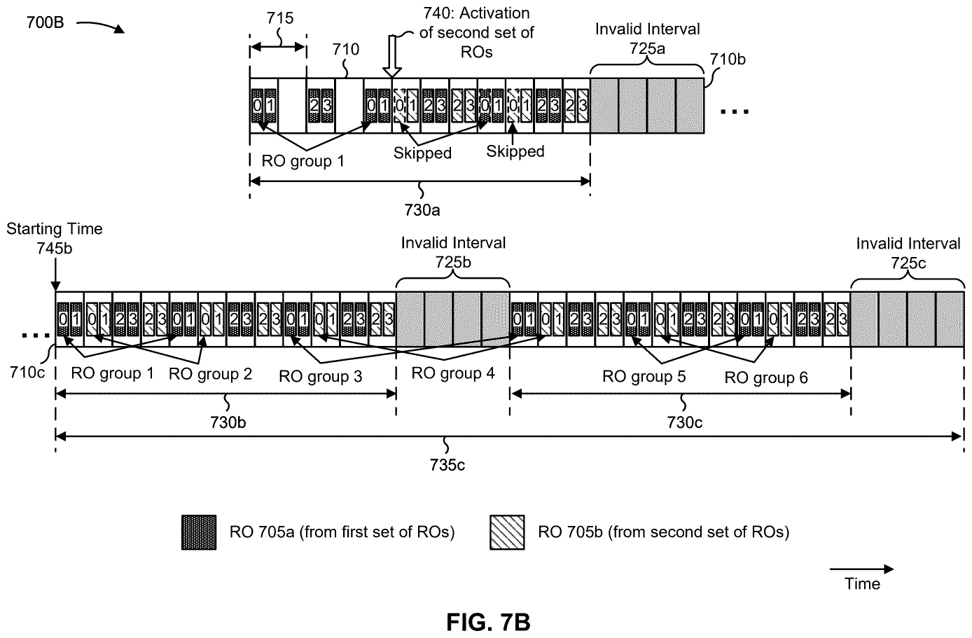

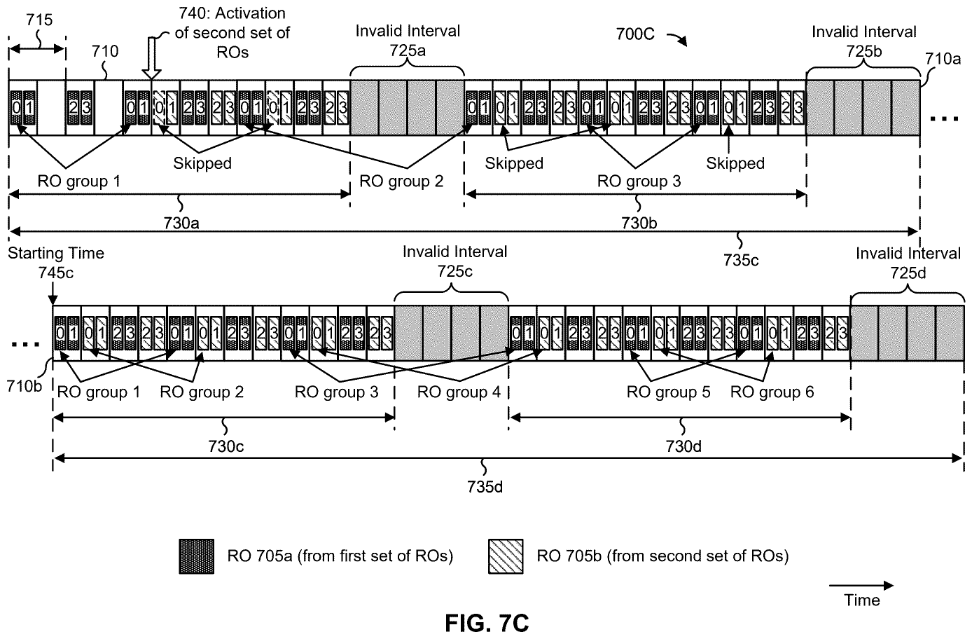

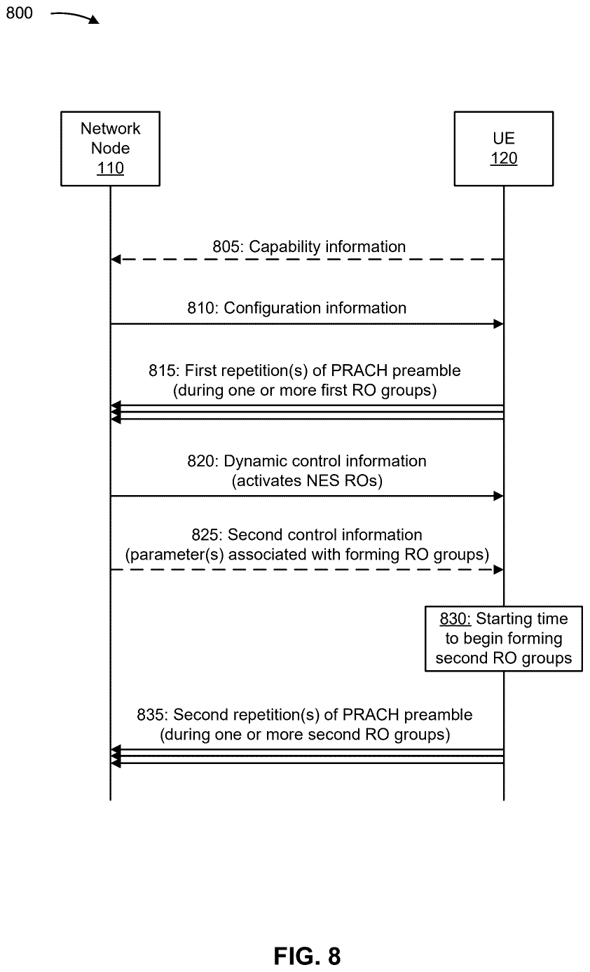

Various aspects relate generally to defining a starting time for the UE 120 to begin forming RO groups using the ROs 505b in accordance with one or more RO grouping rules. FIGS. 6A through 6C describe respective definitions of the starting time in accordance with forming joint-RO groups (e.g., RO groups that include both the ROs 505a and ROs 505b). FIGS. 7A through 7C describe respective definitions of the starting time in accordance with forming independent RO groups (e.g., a first set of RO groups that exclusively include the ROs 505a and a second set of RO groups that exclusively include ROs 505b). FIG. 8 describes signaling between the UE 120 and the network node 110 that enables one or more aspects described herein and defines how UEs 120 of the first capability and UEs 120 of the second capability may jointly or independently determine RO group patterns 535.

As indicated above, FIGS. 5A and 5B are provided as examples. Other examples may differ from what is described with regard to FIGS. 5A and 5B.

FIGS. 6A through 6C are diagrams illustrating respective examples 600A through 600C associated with forming joint RO groups associated with dynamic adaptation of PRACH transmissions, in accordance with the present disclosure. In some examples, FIGS. 6A through 6C may implement or be implemented by one or more aspects of FIGS. 1 through 5B. Specifically, respective examples 600A through 600C may be associated with an RO scheduling structure that is similar to an RO scheduling structure of example 500B. For instance, ROs 605a may be examples of ROs 505a, a set of frames 610 may be examples of the set of frames 510, a PRACH configuration period 615 may be an example of the PRACH configuration period 515, association periods 620a. 620b, and 620c may be respective examples of association periods 520a, 520b, and 520c, invalid intervals 625 (e.g., invalid interval 625a, 625b, and 625c) may be respective examples of the invalid intervals 525, association pattern periods 630a and 630b may be respective examples of the association pattern periods 530a and 530b, and RO group pattern 635 may be an example of the RO group pattern 535. Additionally, reference number 640 may be an example of reference number 540. For example, reference number 640 may be associated with a time at which the network node 110 may activate the ROs 605b for use at the UE 120 (e.g., at the beginning of the sixth frame 610 in examples 600A through 600C).

In accordance with the techniques described herein, the examples 600A through 600C may describe the UE 120 implementing and/or operating in accordance with one or more RO grouping rules to determine a starting time 645 to begin forming joint RO groups that include both ROs 605a and ROs 605b (e.g., RO groups that include both traditional ROs and dynamically activated ROs, as described with reference to FIG. 5B). Additionally, while the examples 600A through 600B show RO groups including two ROs, each RO group may include any number of ROs in accordance with the

$${N}_{preamble}^{rep}$$

parameter. Additionally, while examples 600A through 600C show RO groups that include ROs mapped to SSB0, the RO groups may be mapped to one or more SSB indexes that are configured by the network node.

FIG. 6A is a diagram illustrating an example 600A associated with forming joint RO groups after activation of dynamically activated ROs, in accordance with the present disclosure. That is, the UE 120 operates in accordance with one or more RO grouping rules that indicate to begin forming joint RO groups as soon as the ROs 605b are activated.

As shown in example 600A, during the association pattern period 630a, the UE 120 forms RO group 1 before the activation of the ROs 605b. Therefore, the RO group 1 of association pattern period 630a may exclusively include ROs 605a. In accordance with the activation of the ROs 605b (e.g., at reference number 640), the UE 120 may begin forming joint RO groups at a starting time 645a. For example, the starting time 645a may be at the start of the ninth frame 610, where the UE 120 may form an RO group 3 (e.g., a joint RO group) that includes an RO 605a mapped to SSB0 from the ninth frame 610 and an RO 605b mapped to SSB0 from the tenth frame 610 of association pattern period 630a. Therefore, the techniques of example 600A deviate from example 500B. For example, with reference to example 5B, the UE 120 forms RO group 2 that includes the RO 505a from the ninth frame 510 of association pattern period 530a and the RO 505a from the first frame 510 of association pattern period 530b. Conversely, in example 600A, the UE 120 refrains from forming the second RO group because the second RO group would span multiple association pattern periods 630 and would exclusively include ROs 605a. Such aspects may be in accordance with the one or more RO grouping rules.

Additionally, as shown in example 600A, the UE 120 skips (e.g., drops) an RO 605b mapped to the SSB0 from the sixth frame 610 of association pattern period 630a (e.g., in accordance with the one or more RO grouping rules). The UE 120 may skip the RO 605b, such that the UE 120 may form the third RO group of association pattern period 630a in accordance with a same RO order associated with forming the joint RO groups of association pattern period 630b. For example, RO group 1, RO group 2, and RO group 3 of association pattern period 630b each include a respective RO 605a and a respective RO 605b, where the respective RO 605a is before the respective RO 605b in the time domain. Therefore, the UE 120 may skip the RO 605b of the sixth frame 610 such that the UE 120 may form the third RO group of association pattern period 630a that includes an RO 605a that is before an RO 605b in the time domain.

Therefore, with reference to example 600A, the starting time 645a is at the start of the ninth frame 610 of the association pattern period 630a, in accordance with the one or more RO grouping rules described herein. Particular aspects of the subject matter described in example 600A can be implemented to realize one or more of the following potential advantages. In some examples, the described techniques can be used to reduce a duration of one or more RO group patterns 635. For example, as illustrated in FIG. 6A, each RO 605 mapped to SSB0 included in association pattern period 630b is included in an RO group, which means that a corresponding RO group pattern 635a may exclusively include the association pattern period 630b (e.g., rather than multiple association pattern periods 535, as described with reference to example 500A and 500B). Such reductions in the duration of RO group patterns 635 may reduce a time in which to perform the associated RACH procedure. Additionally, the aspects of example 600A may allow the UE 120 to start transmitting repetitions of the PRACH preamble via ROs 605b as soon as the ROs 605b are activated, which may allow the UE 120 to make joint RO groups earlier in time, thus increasing PRACH resource utilization and reducing latency associated with performing an associated RACH procedure.

FIG. 6B is a diagram illustrating an example 600B associated with forming joint RO groups during the next association pattern period after activation of the dynamically activated ROs, in accordance with the present disclosure. That is, the UE 120 operates in accordance with one or more RO grouping rules that indicate to begin forming joint RO groups at the beginning of the next association pattern period 630 (e.g., the beginning of the association pattern period 630b).

As shown in example 600B, during the association pattern period 630a, the UE 120 forms RO group 1 before the activation of the ROs 605b. Therefore, the RO group 1 of association pattern period 630a may exclusively include ROs 605a. In accordance with the activation of the ROs 605b (e.g., at reference number 640), the UE 120 may begin forming joint RO groups at a starting time 645b. For example, the starting time 645b may be at the start of the earliest frame 610 of the next association pattern period 630, where the earliest frame 610 includes an RO 605a or an RO 605b that is mapped to the SSB index associated with an RACH procedure for the UE 120. For instance, with reference to example 600B, the starting time 645b is at the start of the first frame 610 of association pattern period 630b based on the first frame 610 including an RO 605a that is mapped to SSB0.

Therefore, the techniques of example 600B deviate from example 500B. For example, with reference to example 500B, the UE 120 forms RO group 2 that includes the RO 505a from the ninth frame 510 of association pattern period 530a and the RO 505a from the first frame 510 of association pattern period 530b. Conversely, in example 600B, the UE 120 refrains from forming the second RO group because the second RO group would span multiple association pattern periods 630 and would exclusively include ROs 605a. Such aspects may be in accordance with the one or more RO grouping rules.

Additionally, as shown in example 600B, during association pattern period 630a, the UE 120 skips (e.g., drops) an RO 605b mapped to the SSB0 from the sixth frame 610, skips an RO 605a mapped to the SSB0 from the ninth frame 610, and skips an RO 605b mapped to the SSB0 from the tenth frame 610 (e.g., in accordance with the one or more RO grouping rules). The UE 120 may skip the ROs 605b of the association pattern period 630a because the one or more RO grouping rules indicate for the UE 120 to refrain from forming joint RO groups until the association pattern period 630b. Additionally, the UE 120 may skip the RO 605a, in the ninth frame, of the association pattern period 630a because the skipped RO 605a is the only remaining RO 605a in association pattern period 630a, and RO groups are configured to include two ROs 605 per group. As described herein “skipping” or “dropping” an RO 605b may described that the UE 120 is unable to use the RO 605b for repetitions based on the joint RO groups are not yet activated. However, the UE may use such skipped or dropped ROs 605b for traditional PRACH procedures (e.g., non-NES PRACH procedures) without an associated repetition.

Therefore, with reference to example 600B, the starting time 645b is at the start of the first frame 610 of association pattern period 630b, in accordance with the one or more RO grouping rules described herein. Particular aspects of the subject matter described in example 600B can be implemented to realize one or more of the following potential advantages. For example, by waiting until the association pattern period 630b to start forming joint RO groups, the UE 120 may continue to form RO groups that exclusively include ROs 605a during association pattern period 630a rather than switching part way through association pattern period 630a to start forming joint RO groups, which may reduce complexity at the UE 120 in forming RO groups. Additionally, the described techniques can be used to reduce a duration of one or more RO group patterns 635. For example, as illustrated in FIG. 6B, each RO 605 mapped to SSB0 included in association pattern period 630b is included in an RO group, which means that a corresponding RO group pattern 635b may exclusively include the association pattern period 630b (e.g., rather than multiple association pattern periods 535, as described with reference to example 500A and 500B). Such reductions in the duration of RO group patterns 635 may reduce a time to perform the associated RACH procedure.

FIG. 6C is a diagram illustrating an example 600C associated with forming joint RO groups after a current active RO group pattern and after activation of the dynamically activated ROs, in accordance with the present disclosure. That is, the UE 120 operates in accordance with one or more RO grouping rules that indicate to begin forming joint RO groups after the RO group pattern 635c is complete.

As shown in example 600C, during the association pattern period 630a, the UE 120 forms RO group 1 before the activation of the ROs 605b. Therefore, the UE 120 may continue to form RO groups that exclusively include ROs 605a until the RO group pattern 635c is complete. For example, the RO group pattern 635c may include the association pattern periods 630a and 630b such that the UE 120 may form RO group 1, RO group 2, and RO group 3 during the RO group pattern 635c. Therefore, the starting time 645c may be at the start of the earliest frame 610 after the RO group pattern 635c, where the earliest frame 610 includes an RO 605a or an RO 605b that is mapped to the SSB index associated with a RACH procedure for the UE 120. For instance, with reference to example 600C, the RO group pattern 635c may complete at the end of a frame 610a, where a frame 610b is directly after the frame 610a in time. Accordingly, the starting time 645c is at the start of the frame 610b based on the frame 610b including an RO 605 that is mapped to SSB0. Additionally, the start of frame 610b may be associated with an association pattern period 630c.

Additionally, as shown in example 600C, the UE 120 skips (e.g., drops) all ROs 605b during the RO group pattern 635c while forming the RO groups (e.g., in accordance with the one or more RO grouping rules). Therefore, with reference to example 600C, the starting time 645c is at the start of the frame 610b, in accordance with the one or more RO grouping rules described herein. As described herein “skipping” or “dropping” an RO 605b may described that the UE 120 is unable to use the RO 605b for repetitions based on the joint RO groups are not yet activated. However, the UE may use such skipped or dropped ROs 605b for traditional PRACH procedures (e.g., non-NES PRACH procedures) without an associated repetition.

Particular aspects of the subject matter described in example 600C can be implemented to realize one or more of the following potential advantages. For example, by waiting until completing the current RO group pattern 635c, the UE 120 may continue to form RO groups that exclusively include ROs 605a during RO group pattern 635 rather than switching part way through RO group pattern 635c to start forming joint RO groups, which may reduce complexity at the UE 120 in forming RO groups. Additionally, the described techniques can be used to reduce a duration of one or more RO group patterns 635. For example, as illustrated in FIG. 6C, each RO 605 mapped to SSB0 after frame 610b is included in an RO group, which means that a corresponding RO group pattern 635d may exclusively include the association pattern period 630c (e.g., rather than multiple association pattern periods 535, as described with reference to example 500A and 500B). Such reductions in the duration of RO group patterns 635d may reduce a time to perform the associated RACH procedure.

As indicated above, FIGS. 6A through 6C are provided as examples. Other examples may differ from what is described with regard to FIGS. 6A through 6C.

FIGS. 7A through 7C are diagrams illustrating respective examples 700A through 700C associated with forming independent RO groups associated with dynamic adaptation of PRACH transmissions, in accordance with the present disclosure. In some examples, FIGS. 7A through 7C may implement or be implemented by one or more aspects of FIGS. 1 through 5B. Specifically, respective examples 700A through 700C may be associated with an RO scheduling structure that is similar to an RO scheduling structure of example 500B. For instance, ROs 705a may be examples of ROs 505a, a set of frames 710 may be examples of the set of frames 510, a PRACH configuration period 715 may be an example of the PRACH configuration period 515, invalid intervals 725 (e.g., invalid intervals 725a, 725b, 725c, and 725d) may be respective examples of the invalid intervals 525, association pattern periods 730a and 730b may be respective examples of the association pattern periods 530a and 530b, and RO group pattern 735 may be an example of the RO group pattern 535. Additionally, reference number 740 may be an example of reference number 540. For example, reference number 740 may be associated with a time at which the network node 110 may activate the ROs 705b for use at the UE 120 (e.g., at the beginning of the sixth frame 710 in example 700A through 700C).

In accordance with the techniques described herein, the examples 700A through 700C may describe the UE 120 implementing and/or operating in accordance with one or more RO grouping rules to determine a starting time 745 to begin forming independent RO groups, where the independent RO groups include a first subset of RO groups that exclusively include ROs 705a and a second subset of RO groups that exclusively include ROs 705b. That is, the first subset of RO groups are associated with traditional ROs and the second subset of RO groups are associated with dynamically activated ROs, as described with reference to FIG. 5B. Additionally, while the examples 700A through 700B show RO groups including two ROs, each RO group may include any number of ROs in accordance with the

$${N}_{preamble}^{rep}$$

parameter. Additionally, while examples 700A through 700C show RO groups that include ROs mapped to SSB0, the RO groups may be mapped to one or more SSB indexes that are configured by the network node 110.

FIG. 7A is a diagram illustrating an example 700A associated with forming independent RO groups after activation of dynamically activated ROs, in accordance with the present disclosure. That is, the UE 120 operates in accordance with one or more RO grouping rules that indicate to begin forming independent RO groups as soon as the ROs 705b are activated.

As shown in example 700A, during the association pattern period 730a, the UE 120 forms RO group 1 before the activation of the ROs 705b. Therefore, the RO group 1 of association pattern period 730a may exclusively include ROs 705a. In accordance with the activation of the ROs 705b (e.g., at reference number 740), the UE 120 may begin forming independent RO groups at a starting time 745a. For example, the starting time 745a may be at the start of the sixth frame 710 of association pattern period 730a. Therefore, the UE 120 may from an RO group 3 (e.g., a first independent RO group) that includes an RO 705a mapped to SSB0 from the ninth frame 710 of the association pattern period 730a and an RO 705a mapped to SSB0 from the first frame 710 of association pattern period 730b. Additionally, the UE may form an RO group 4 (e.g., a second independent RO group) that includes an RO 705b mapped to SSB0 from the tenth frame 710 of the association pattern period 730a and an RO 705b mapped to SSB0 from the second frame 710 of association pattern period 730b. The UE may continue to form a fifth RO group (that exclusively includes ROs 705a) and a sixth RO group (that exclusively includes ROs 705b) such that each RO 705 mapped to SSB0 is included in a group in accordance with an RO group pattern 735a. Such aspects may be in accordance with the one or more RO grouping rules.

Additionally, as shown in example 700A, the UE 120 skips (e.g., drops) an RO 705b mapped to the SSB0 from the sixth frame 710 of association pattern period 730a (e.g., in accordance with the one or more RO grouping rules). The UE 120 may skip the RO 705b mapped to the SSB0 from the sixth frame 710 because the UE 120 would have included it in a second RO group if there were an activate RO 705b mapped to SSB from the second frame of association pattern period 730a. Therefore, the UE skips forming RO group 2 during the RO group pattern 735a in accordance with the one or more RO grouping rules. As described herein “skipping” or “dropping” an RO 705b may described that the UE 120 is unable to use the RO 705b for repetitions based on the joint RO groups are not yet activated. However, the UE may use such skipped or dropped ROs 705b for traditional PRACH procedures (e.g., non-NES PRACH procedures) without an associated repetition.

Additionally, the UE may continue forming RO groups during an RO group pattern 735b. For instance, as shown in FIG. 7A, the RO group pattern 735a may conclude at the end of a frame 710a and the RO group pattern 735a may begin at the start of a frame 710b, where the frame 710b is directly after the frame 710a in time. The RO group pattern 735b may span an association pattern period 730c and 730d and an invalid interval 725c and 725d. Additionally, the UE 120 may form independent RO groups during the RO group pattern 735b in accordance with the one or more RO grouping rules. For example, RO group 1, 3, and 5 of RO group pattern 735b may exclusively include ROs 705a mapped to SSB0 and example RO group 2, 4, and 6 of RO group pattern 735b may exclusively include ROs 705a mapped to SSB0 (e.g., in accordance with forming independent RO groups).

With reference to example 700A, the starting time 745a is at the start of the sixth frame 710 of the association pattern period 730a, in accordance with the one or more RO grouping rules described herein. Particular aspects of the subject matter described in example 700A can be implemented to realize one or more of the following potential advantages. For example, the aspects of example 700A may allow the UE 120 to start transmitting repetitions of the PRACH preamble via ROs 705b as soon as the ROs 705b are activated, which may allow the UE 120 to form independent RO groups earlier in time, thus increasing PRACH resource utilization and reducing latency associated with performing an associated RACH procedure. Additionally, the described techniques can be used to increase a number of RO groups included in one or more RO group patterns 735. For example, as illustrated in FIG. 7A, the RO group pattern 735b includes twice as many RO groups compared to RO group pattern 535 as described with reference to FIGS. 5A and 5B. As such, the techniques of FIG. 7A may allow the UE to transmit more repetitions of a PRACH preamble in a same duration, which may increase the efficiency of an associated RACH procedure.

FIG. 7B is a diagram illustrating an example 700B associated with forming independent RO groups during a next association pattern period after activation of dynamically activated ROs, in accordance with the present disclosure. That is, the UE 120 operates in accordance with one or more RO grouping rules that indicate to begin forming independent RO groups at the beginning of the next association pattern period 730 (e.g., the beginning of the association pattern period 730b).

As shown in example 700B, during the association pattern period 730a, the UE 120 forms RO group 1 before the activation of the ROs 705b. Therefore, the RO group 1 of association pattern period 730a may exclusively include ROs 705a. In accordance with the activation of the ROs 705b (e.g., at reference number 740), the UE 120 may begin forming independent RO groups at a starting time 745b. For example, the starting time 745b may be at the start of the earliest frame 710 of the next association pattern period 730, where the earliest frame 710 includes an RO 705a or an RO 705b that is mapped to the SSB index associated with RACH procedure for the UE 120. For instance, with reference to example 700B, the starting time 745b is at the start of the first frame 710 of association pattern period 730b based on the first frame 710 including an RO 705a that is mapped to SSB0.

Therefore, the techniques of example 700B deviate from example 500B. For example, with reference to example 500B, the UE 120 forms RO group 2 that includes the RO 505a mapped to SSB0 from the ninth frame 510 of association pattern period 530a and the RO 505a mapped to SSB0 from the first frame 510 of association pattern period 530b. Additionally, in example 500B, the UE 120 forms RO group 3 that includes the RO 505a mapped to SSB0 from the fifth frame 510 of association pattern period 530b and the RO 505a mapped to SSB0 from the ninth frame 510 of association pattern period 530b. Conversely, in example 700B, the UE 120 refrains from forming the second RO group or the third RO group because the second and third RO group span association pattern period 730b, which is associated with independent RO groups based on starting time 745b. Such aspects may be in accordance with the one or more RO grouping rules.

Additionally, as shown in example 700B, during association pattern period 730a the UE 120 skips (e.g., drops) an RO 705b mapped to the SSB0 from the sixth frame 710, skips an RO 705a mapped to the SSB0 from the ninth frame 710, and skips an RO 705b mapped to the SSB0 from the tenth frame 710 (e.g., in accordance with the one or more RO grouping rules). The UE 120 may skip the ROs 705b of the association pattern period 730a because the one or more RO grouping rules indicate for the UE 120 to refrain from forming independent RO groups until the association pattern period 730b. Additionally, the UE 120 may skip the RO 705a of the association pattern period 730a because the skipped RO 705a is the only remaining RO 705a in association pattern period 730a, and RO groups are configured to include two ROs 705 per group. As described herein “skipping” or “dropping” an RO 705b may described that the UE 120 is unable to use the RO 705b for repetitions based on the joint RO groups are not yet activated. However, the UE may use such skipped or dropped ROs 705b for traditional PRACH procedures (e.g., non-NES PRACH procedures) without an associated repetition.

As shown in FIG. 7B, the UE 120 may start forming independent RO groups at the start of association pattern period 730b. For instance, as shown in FIG. 7B, the association pattern period 635b may begin at the start of a frame 710c which may be directly subsequent in time to the end of a frame 710b. Therefore, with reference to example 700B, the starting time 745b is at the start of the first frame 710 of association pattern period 730b, in accordance with the one or more RO grouping rules described herein. Additionally, the association pattern period 730b may be associated with an RO group pattern 735c which includes the association pattern period 730b and an association pattern period 730c. As shown in FIG. 7B, the UE 120 may form independent RO groups during the RO group pattern 735c such that each RO 705 mapped to SSB0 is included in an RO group. For example, during the RO group pattern 735c the UE 120 may form RO group 1, 3, and 5 which may exclusively include ROs 705a and may form RO group 2, 4, and 6 which may exclusively include ROs 705b (e.g., in accordance with forming independent RO groups).

Particular aspects of the subject matter described in example 700B can be implemented to realize one or more of the following potential advantages. For example, by waiting until the association pattern period 730b to start forming independent RO groups, the UE 120 may continue to form RO groups that exclusively include ROs 705a during association pattern period 730a, rather than switching part way through association pattern period 730a to start forming independent RO groups, which may reduce complexity at the UE 120 in forming RO groups. Additionally, the described techniques can be used to increase a number of RO groups included in one or more RO group patterns 735. For example, as illustrated in FIG. 7B, the RO group pattern 735c includes twice as many RO groups compared to RO group pattern 535 as described with reference to FIGS. 5A and 5B. As such, the techniques of FIG. 7B may allow the UE 120 to transmit more repetitions of a PRACH preamble in a same duration, which may increase the efficiency of an associated RACH procedure.

FIG. 7C is a diagram illustrating an example 700C associated with forming independent RO groups after a current active RO group pattern and after activation of the dynamically activated ROs, in accordance with the present disclosure. That is, the UE 120 operates in accordance with one or more RO grouping rules that indicate to begin forming independent RO groups after an RO group pattern 735c is complete.

As shown in example 700C, during the association pattern period 730a, the UE 120 forms RO group 1 before the activation of the ROs 705b. Therefore, the UE 120 may continue to form RO groups that exclusively include ROs 705a until the RO group pattern 735c is complete. For example, the RO group pattern 735c may include the association pattern periods 730a and 730b such that the UE 120 may form RO group 1, RO group 2, and RO group 3 during the RO group pattern 535. Therefore, the starting time 745c may be at the start of the earliest frame 710 after the RO group pattern 735c, where the earliest frame 710 includes an RO 705a or an RO 705b that is mapped to the SSB index associated with RACH procedure for the UE 120. For instance, with reference to example 700C, the RO group pattern 735 may complete at the end of a frame 710a, where a frame 710b is directly after the frame 710a in time. Accordingly, the starting time 745c is at the start of the frame 710b based on the frame 710b including an RO 705 that is mapped to SSB0.

Therefore, in accordance with the starting time 745c, the UE 120 may begin to form the independent RO groups. For instance, with reference to example 700C, the UE 120 may form six independent RO groups during an association pattern period 730c and 730d, which may be included in an RO pattern group 735d. For instance, in RO pattern group 735d. RO group 1, RO group 3, and RO group 5 may be examples of independent RO groups that include exclusive ROs 705a that are mapped to SSB0. Additionally, in RO pattern group 735d, RO group 2. RO group 4, and RO group 6 may be examples of independent RO groups that include exclusive ROs 705b that are mapped to SSB0.

Additionally, as shown in example 700C, the UE 120 skips (e.g., drops) all ROs 705b during the RO group pattern 735c while forming the RO groups (e.g., in accordance with the one or more RO grouping rules). Therefore, with reference to example 700C, the starting time 745c is at the start of the frame 710b, in accordance with the one or more RO grouping rules described herein. As described herein “skipping” or “dropping” an RO 705b may described that the UE 120 is unable to use the RO 705b for repetitions based on the joint RO groups are not yet activated. However, the UE may use such skipped or dropped ROs 705b for traditional PRACH procedures (e.g., non-NES PRACH procedures) without an associated repetition.

Particular aspects of the subject matter described in example 700C can be implemented to realize one or more of the following potential advantages. For example, by waiting until completing the current RO group pattern 735, the UE 120 may continue to form RO groups that exclusively include ROs 705a during RO group pattern 735 rather than switching part way through RO group pattern 735 to start forming independent RO groups, which may reduce complexity at the UE 120 in forming RO groups. Additionally, by operating in accordance with independent RO groups, the UE 120 may form more RO groups in a same duration. For instance, RO group pattern 735c may include three RO groups while RO group pattern 735d may include six independent RO groups, which may increase the efficiency of the associated RO procedure.

As indicated above, FIGS. 7A through 7C are provided as examples. Other examples may differ from what is described with regard to FIGS. 7A through 7C.

FIG. 8 is a diagram illustrating an example 800 associated with dynamic adaptation of PRACH transmissions, in accordance with the present disclosure. Example 800 may implement or be implemented by one or more aspects of FIGS. 1 through 7. For instance, example 800 includes wireless communications between the UE 120 and the network node 110. Alternative examples of the following may be implemented, where some operations are performed in a different order than described, or not described at all. In some cases, one or more operations may include additional features not mentioned below, or further operations may be added. In addition, while example 800 shows operations between the UE 120 and the network node 110, the communication may occur between any number of network devices of various types described herein.

In some aspects, as shown by a first operation 805, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the UE 120. The one or more parameters may be indicated via respective information elements (IEs) included in the capability report.

The capability information may indicate whether the UE 120 supports a feature and/or one or more parameters related to the feature. For example, the capability information may indicate a capability and/or parameter for supporting one or more capability protocols, such as supporting the transmission of PRACH preambles during dynamically activated ROs. That is, the capability information may indicate that the UE 120 is associated with the first capability (e.g., NES capability). Additionally, the capability information may indicate a capability and/or parameter for supporting the formation of joint RO groups (e.g., that include both traditional ROs and dynamically activated ROs) and/or the formation of independent RO groups (e.g., that include a first subset of RO groups that include exclusively traditional ROs and a second subset of RO groups that include exclusively dynamically activated ROs). In some examples, “traditional ROs” may refer to the ROs 505a, 605a, and 705a and “dynamically activated ROs” may refer to the ROs 505b, 605b, and 705b, as described with reference to FIGS. 5 through 7. One or more operations described herein may be based on capability information. For example, the UE 120 may perform a communication in accordance with the capability information or may receive configuration information that is in accordance with the capability information.

The network node 110 may determine configuration information for the UE 120 based on the capability information. For example, the network node 110 may determine that the UE 120 is to be configured with a first set of ROs that include traditional ROs and a second set of ROs that include dynamically activated ROs based on the capability information indicating that the UE 120 supports the transmission of PRACH preambles during dynamically activated ROs. Additionally, the network node 110 may determine that the UE 120 is to operate in accordance with forming joint RO groups and/or independent RO groups based on the capability information indicating that the UE 120 supports the formation of joint RO groups and/or the formation of independent RO groups. In other examples, the network node 110 may determine the configuration information without, or independently of, the capability information. For example, the network node 110 may determine that the UE 120 is associated with the first capability and/or that the UE 120 supports the use of dynamically activated ROS based on a type, category, or other classification of the UE 120.

In a second operation 810, the network node 110 may transmit, and the UE 120 may receive, the configuration information. In some aspects, the UE 120 may receive the configuration information via one or more of system information signaling (e.g., a MIB and/or a SIB, among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate the first set of ROs (e.g., ROs 505a, 605a, and/or 705a) and the second set of ROs (e.g., ROs 505b, 605b, and/or 705b). In some examples, the network node 110 may indicate the first and second sets of ROs in a single PRACH configuration. In some other examples, the network node 110 may indicate the first set of ROs in a first PRACH configuration and indicate the second set of ROs in a second PRACH configuration.

In some aspects, the configuration information may initially activate the first set of ROs, but not the second set of ROs. In some examples, the configuration information may indicate that both the first set of ROs and the second set of ROs are initially deactivated. In some examples, the network node 110 may transmit, and the UE 120 may receive, dynamic signaling (such as a MAC-CE or DCI) that activates and/or deactivates the first set of ROs and/or the second set of ROs.

In a third operation 815, the UE 120 may transmit, and the network node 110 may receive, one or more first repetitions of a PRACH preamble during one or more first RO groups. For example, the one or more first RO groups may include the first set of ROs that are mapped to an SSB (such as RO group 1 in association pattern periods 630a or 730a as described with reference to FIGS. 6 and 7). In some examples, the first repetitions of the PRACH preamble may be an example of msg1 with repetitions, as described with reference to FIG. 3.

In a fourth operation 820, the network node 110 may transmit, and the UE 120 may receive, dynamic control information. For example, the dynamic control information may activate the second set of ROs (e.g., the dynamically activated ROS). Additionally, the second set of ROs may also be mapped to the SSB associated with the first set of ROs (e.g., SSB0 with reference to FIGS. 5 through 7). In some aspects, the dynamic control information may be MAC-CE signaling or DCI signaling. In some examples, the network node 110 may transmit the dynamic control information based on one or more capability protocols (as described with reference to FIG. 5B). In some examples, the UE 120 may transmit the dynamic control information based on the capability information from the UE 120 indicating that the UE 120 supports dynamically activated ROs and/or based on the type, category, or other classification of the UE 120. In some examples, the dynamic control information may be associated with the reference number 540, 640, and/or 740, as described with reference to FIGS. 5 through 7.

In some aspects, as shown by a fifth operation 825, the network node 110 may optionally transmit, and the UE 120 may receive, second control information. In some aspects, the UE 120 may receive the control information via one or more of system information signaling (e.g., a MIB and/or a SIB, among other examples), RRC signaling, MAC signaling (e.g., one or more MAC-CEs), and/or DCI, among other examples. In some examples, one or more portions of information indicated in the second control information may be alternatively indicated as part the configuration information in the first operation 805.

In some aspects, the second control information indicates one or more parameters associated with forming RO groups. For example, the one or more parameters may include one or more of a number of PRACH preamble repetitions per RO group or a number of RO groups to form for a RACH procedure. In some examples, the second control information may indicate or be indicative of one or more rules for forming RO group patterns based on a capability or type associated with the UE 120 (e.g., whether the UE 120 is associated with the first capability). In some examples, the one or more rules for forming RO group patterns may be at least partially defined in a wireless communications standard, such as 3GPP.

At a sixth operation 830, the UE 120 may begin to form one or more second RO groups that include both the first set of ROs and the second set of ROs in accordance with one or more RO grouping rules. In some examples, the network node 110 may indicate the one or more RO grouping rules as part of the configuration information in the first operation 805. Additionally, or alternatively, the network node 110 may indicate the one or more RO grouping rules as part of the dynamic control information in the second operation 810. Additionally, or alternatively, the one or more RO grouping rules may at least partially be defined by a wireless communication standard, such as the 3GPP.

As described herein, a starting time at which the UE 120 begins to form the one or more second RO groups is in accordance with the one or more RO grouping rules (e.g., the starting time 645 and/or the starting time 745).

In some aspects, the one or more RO groups each include at least one RO from the first set of ROs and at least one RO from the second set of ROs in accordance with a joint RO grouping pattern (e.g., joint RO groups, with reference to FIGS. 6A through 6C). In some examples, the starting time is an earliest time at which an RO associated with the one or more second RO groups is available, where the earliest time is after activation of the second set of ROs, and where the starting time is based on the one or more RO grouping rules being associated with forming the one or more second RO groups in accordance with the activation of the second set of ROs (e.g., in accordance with aspects of FIG. 6A). In some examples, the starting time is an earliest time at which an RO associated with the one or more second RO groups is available, where the earliest time is in a next association pattern period after activation of the second set of ROs, and where the starting time is based on the one or more RO grouping rules being associated with forming the one or more second RO groups in accordance with the next association pattern period after the activation of the second set of RO groups (e.g., in accordance with aspects of FIG. 6B). In some examples, the starting time is an earliest time at which an RO associated with the one or more second RO groups is available, where the earliest time is after an active RO group pattern associated with forming the one or more first RO groups, and where the starting time is based on the one or more RO grouping rules being associated with forming the one or more second RO groups after the active RO group pattern (e.g., in accordance with aspects of FIG. 6C).

In some aspects, the one or more second RO groups include a first subset of second RO groups that include exclusively ROs from the first set of ROs and a second subset of second RO groups that include exclusively ROs from the second set of ROs in accordance with an independent RO grouping pattern (e.g., independent RO groups, with reference to FIGS. 7A through 7C). In some examples, the starting time is an earliest time at which an RO associated with the one or more second RO groups is available, where the earliest time is after activation of the second set of ROs, and where the starting time is based on the one or more RO grouping rules being associated with forming the one or more second RO groups in accordance with the activation of the second set of RO groups (e.g., in accordance with aspects of FIG. 7A). In some examples, the starting time is an earliest time at which an RO associated with the one or more second RO groups is available, where the earliest time is in a next association pattern period after activation of the second set of ROs, and where the starting time is based on the one or more RO grouping rules being associated with forming the one or more second RO groups in accordance with the next association pattern period after the activation of the second set of RO groups (e.g., in accordance with aspects of FIG. 7B). In some examples, the starting time is an earliest time at which an RO associated with the one or more second RO groups is available, where the earliest time is after an active RO group pattern associated with forming the one or more first RO groups, and where the starting time is based on the one or more RO grouping rules being associated with forming the one or more second RO groups after the active RO group pattern (e.g., in accordance with aspects of FIG. 7C).

In some aspects, the RO group pattern associated with forming the second set of RO groups may be based on the second control information and/or a capability of the UE 120. For instance, as illustrated with reference to FIG. 6C, the three joint RO groups, formed in accordance with the starting time 645c, satisfy the conditions of an RO group pattern that is associated with a single association pattern period (e.g., an RO group pattern with a value of K=1). However, UEs 120 that are not associated with the first capability (e.g., legacy UEs 120) may not form joint RO groups, and therefore such UEs 120 may form three RO groups over two association pattern periods 630 (e.g., an RO group pattern with a value of K=2). That is, the duration associated with an RO group pattern may be based on the first capability of the UE 120.

In some aspects, the second control information and/or a wireless communications standard may indicate a first RO group pattern formation for UEs 120 associated with the first capability and a second RO group pattern formation for UEs 120 not associated with the first capability that is independent of the first RO group pattern formation. For instance, with reference to FIG. 6C, the first RO group pattern formation may be associated with a value of K=1 and the second RO group pattern formation may be associated with a value of K=2. By incorporating the first RO group pattern formation for UEs 120 with the first capability, such UEs 120 of the first capability may reduce the duration associated with RO group patterns, which may increase the efficiency of associated RACH procedures.

In some aspects, the second control information and/or a wireless communications standard may indicate a single RO group pattern formation for UEs 120 associated with the first capability and UEs 120 associated with the second capability. For instance, with reference to FIG. 6C, the single RO group pattern formation may be associated with a value of K=2 irrespective of a capability of a given UE 120. In some examples, the single RO group pattern formation for UEs 120 regardless of capability may reduce complexity associated with defining separate parameters based on UE capability.

In a seventh operation 835, the UE 120 may transmit, and the network node 110 may receive, one or more second repetitions of the PRACH preamble during the one or more second RO groups that are formed in accordance with the sixth operation 830. In some examples, the second repetitions of the PRACH preamble may be an example of msg1 with repetitions, as described with reference to FIG. 3. In accordance with communicating the first and second repetitions of the PRACH preamble, the network node 110 and UE 120 may continue to perform an associated RACH procedure to establish a connection (e.g., a 2-step RACH or a 4-step RACH in accordance with aspects of FIG. 3).

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with dynamic adaptation of physical random access channel transmissions.

As shown in FIG. 9, in some aspects, process 900 may include transmitting, to a network node, one or more first repetitions of a PRACH preamble during one or more first RO groups, wherein the one or more first RO groups include a first set of ROs that are mapped to a SSB (block 910). For example, the UE (e.g., using transmission component 1104 and/or communication manager 1106, depicted in FIG. 11) may transmit, to a network node, one or more first repetitions of a PRACH preamble during one or more first RO groups, wherein the one or more first RO groups include a first set of ROs that are mapped to a SSB, as described above.

As further shown in FIG. 9, in some aspects, process 900 may include receiving, from the network node, control information that activates a second set of ROs, wherein the second set of ROs are mapped to the SSB (block 920). For example, the UE (e.g., using reception component 1102 and/or communication manager 1106, depicted in FIG. 11) may receive, from the network node, control information that activates a second set of ROs, wherein the second set of ROs are mapped to the SSB, as described above.

As further shown in FIG. 9, in some aspects, process 900 may include transmitting, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules (block 930). For example, the UE (e.g., using transmission component 1104 and/or communication manager 1106, depicted in FIG. 11) may transmit, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules, as described above.

Process 900 may include additional aspects, such as any single aspect or any combination of aspects described below and/or in connection with one or more other processes described elsewhere herein.

In a first aspect, the one or more second RO groups each include at least one RO from the first set of ROs and at least one RO from the second set of ROs in accordance with a joint RO grouping pattern.

In a second aspect, alone or in combination with the first aspect, the starting time is an earliest time at which an RO associated with the one or more second RO groups is available, wherein the earliest time is after activation of the second set of ROs, and wherein the starting time is based at least in part on the one or more RO grouping rules being associated with forming the one or more second RO groups in accordance with the activation of the second set of ROs.

In a third aspect, alone or in combination with one or more of the first and second aspects, the starting time is an earliest time at which an RO associated with the one or more second RO groups is available, wherein the earliest time is in a next association pattern period after activation of the second set of ROs, and wherein the starting time is based at least in part on the one or more RO grouping rules being associated with forming the one or more second RO groups in accordance with the next association pattern period after the activation of the second set of RO groups.

In a fourth aspect, alone or in combination with one or more of the first through third aspects, the starting time is an earliest time at which an RO associated with the one or more second RO groups is available, wherein the earliest time is after an active RO group pattern associated with forming the one or more first RO groups, and wherein the starting time is based at least in part on the one or more RO grouping rules being associated with forming the one or more second RO groups after the active RO group pattern.

In a fifth aspect, alone or in combination with one or more of the first through fourth aspects, the one or more second RO groups include a first subset of second RO groups that include exclusively ROs from the first set of ROs and a second subset of second RO groups that include exclusively ROs from the second set of ROs in accordance with an independent RO grouping pattern.

In a sixth aspect, alone or in combination with one or more of the first through fifth aspects, the starting time is an earliest time at which an RO associated with the one or more second RO groups is available, wherein the earliest time is after activation of the second set of ROs, and wherein the starting time is based at least in part on the one or more RO grouping rules being associated with forming the one or more second RO groups in accordance with the activation of the second set of RO groups.

In a seventh aspect, alone or in combination with one or more of the first through sixth aspects, the starting time is an earliest time at which an RO associated with the one or more second RO groups is available, wherein the earliest time is in a next association pattern period after activation of the second set of ROs, and wherein the starting time is based at least in part on the one or more RO grouping rules being associated with forming the one or more second RO groups in accordance with the next association pattern period after the activation of the second set of RO groups.

In an eighth aspect, alone or in combination with one or more of the first through seventh aspects, the starting time is an earliest time at which an RO associated with the one or more second RO groups is available, wherein the earliest time is after an active RO group pattern associated with forming the one or more first RO groups, and wherein the starting time is based at least in part on the one or more RO grouping rules being associated with forming the one or more second RO groups after the active RO group pattern.

In a ninth aspect, alone or in combination with one or more of the first through eighth aspects, the control information is first control information, and process 900 includes receiving, from the network node, second control information that indicates one or more parameters associated with forming RO groups, and forming the one or more second RO groups over an RO group pattern, wherein the RO group pattern includes a number of associated pattern periods based at least in part on the control information and a capability of the UE.

In a tenth aspect, alone or in combination with one or more of the first through ninth aspects, the UE is associated with a first RO group pattern formation based at least in part on being associated with a first capability, and the first RO group pattern formation is independent of a second RO group pattern formation for UEs not associated with the first capability.

In an eleventh aspect, alone or in combination with one or more of the first through tenth aspects, the UE is associated with an RO group pattern formation based at least in part on being associated with a first capability, and the RO group pattern formation is additionally for UEs not associated with the first capability.

In a twelfth aspect, alone or in combination with one or more of the first through eleventh aspects, the one or more parameters associated with forming RO groups comprises one or more of a number of PRACH preamble repetitions per RO group or a number of RO groups to form for a RACH procedure.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with dynamic adaptation of PRACH transmissions.

As shown in FIG. 10, in some aspects, process 1000 may include receiving, from a UE, one or more first repetitions of a PRACH preamble during one or more RO groups, wherein the one or more first RO groups include a first set of ROs that are mapped to a RO (block 1010). For example, the network node (e.g., using reception component 1202 and/or communication manager 1206, depicted in FIG. 12) may receive, from a UE, one or more first repetitions of a PRACH preamble during one or more RO groups, wherein the one or more first RO groups include a first set of ROs that are mapped to a RO, as described above.

As further shown in FIG. 10, in some aspects, process 1000 may include transmitting, to the UE, control information that activates a second set of ROs, wherein the second set of ROs are mapped to the SSB (block 1020). For example, the network node (e.g., using transmission component 1204 and/or communication manager 1206, depicted in FIG. 12) may transmit, to the UE, control information that activates a second set of ROs, wherein the second set of ROs are mapped to the SSB, as described above.

As further shown in FIG. 10, in some aspects, process 1000 may include receiving, from the UE after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules (block 1030). For example, the network node (e.g., using reception component 1202 and/or communication manager 1206, depicted in FIG. 12) may receive, from the UE after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules, as described above.

Process 1000 may include additional aspects, such as any single aspect or any combination of aspects described below and/or in connection with one or more other processes described elsewhere herein.

In a first aspect, the one or more second RO groups each include at least one RO from the first set of ROs and at least one RO from the second set of ROs in accordance with a joint RO grouping pattern.

In a second aspect, alone or in combination with the first aspect, the starting time is an earliest time at which an RO associated with the one or more second RO groups is available, wherein the earliest time is after activation of the second set of ROs, and wherein the starting time is based at least in part on the one or more RO grouping rules being associated with forming the one or more second RO groups in accordance with the activation of the second set of ROs.

In a third aspect, alone or in combination with one or more of the first and second aspects, the starting time is an earliest time at which an RO associated with the one or more second RO groups is available, wherein the earliest time is in a next association pattern period after activation of the second set of ROs, and wherein the starting time is based at least in part on the one or more RO grouping rules being associated with forming the one or more second RO groups in accordance with the next association pattern period after the activation of the second set of RO groups.

In a fourth aspect, alone or in combination with one or more of the first through third aspects, the starting time is an earliest time at which an RO associated with the one or more second RO groups is available, wherein the earliest time is after an active RO group pattern associated with forming the one or more first RO groups, and wherein the starting time is based at least in part on the one or more RO grouping rules being associated with forming the one or more second RO groups after the active RO group pattern.

In a fifth aspect, alone or in combination with one or more of the first through fourth aspects, the one or more second RO groups include a first subset of second RO groups that include exclusively ROs from the first set of ROs and a second subset of second RO groups that include exclusively ROs from the second set of ROs in accordance with an independent RO grouping pattern.

In a sixth aspect, alone or in combination with one or more of the first through fifth aspects, the starting time is an earliest time at which an RO associated with the one or more second RO groups is available, wherein the earliest time is after activation of the second set of ROs, and wherein the starting time is based at least in part on the one or more RO grouping rules being associated with forming the one or more second RO groups in accordance with the activation of the second set of RO groups.

In a seventh aspect, alone or in combination with one or more of the first through sixth aspects, the starting time is an earliest time at which an RO associated with the one or more second RO groups is available, wherein the earliest time is in a next association pattern period after activation of the second set of ROs, and wherein the starting time is based at least in part on the one or more RO grouping rules being associated with forming the one or more second RO groups in accordance with the next association pattern period after the activation of the second set of RO groups.

In an eighth aspect, alone or in combination with one or more of the first through seventh aspects, the starting time is an earliest time at which an RO associated with the one or more second RO groups is available, wherein the earliest time is after an active RO group pattern associated with forming the one or more first RO groups, and wherein the starting time is based at least in part on the one or more RO grouping rules being associated with forming the one or more second RO groups after the active RO group pattern.

In a ninth aspect, alone or in combination with one or more of the first through eighth aspects, the control information is first control information, and process 1000 includes transmitting, to the UE, second control information that indicates one or more parameters associated with forming RO groups.

In a tenth aspect, alone or in combination with one or more of the first through ninth aspects, the UE is associated with a first RO group pattern formation based at least in part on being associated with a first capability, and the first RO group pattern formation is independent of a second RO group pattern formation for UEs not associated with the first capability.

In an eleventh aspect, alone or in combination with one or more of the first through tenth aspects, the UE is associated with an RO group pattern formation based at least in part on being associated with a first capability, and the RO group pattern formation is additionally for UEs not associated with the first capability.

In a twelfth aspect, alone or in combination with one or more of the first through eleventh aspects, the one or more parameters associated with forming RO groups comprises one or more of a number of PRACH preamble repetitions per RO group or a number of RO groups to form for a RACH procedure.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 1 through 8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to a network node, one or more first repetitions of a PRACH preamble during one or more first RO groups, wherein the one or more first RO groups include a first set of ROs that are mapped to a SSB. The reception component 1102 may receive, from the network node, control information that activates a second set of ROs, wherein the second set of ROs are mapped to the SSB. The transmission component 1104 may transmit, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 3 through 8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a UE, one or more first repetitions of a PRACH preamble during one or more RO groups, wherein the one or more first RO groups include a first set of ROs that are mapped to a RO. The transmission component 1204 may transmit, to the UE, control information that activates a second set of ROs, wherein the second set of ROs are mapped to the SSB. The reception component 1202 may receive, from the UE after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: transmitting, to a network node, one or more first repetitions of a PRACH preamble during one or more first random access channel (RACH) occasion (RO) groups, wherein the one or more first RO groups include a first set of ROs that are mapped to a synchronization signal block (SSB); receiving, from the network node, control information that activates a second set of ROs, wherein the second set of ROs are mapped to the SSB; and transmitting, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules.

Aspect 2: The method of Aspect 1, wherein the one or more second RO groups each include at least one RO from the first set of ROs and at least one RO from the second set of ROs in accordance with a joint RO grouping pattern.

Aspect 3: The method of Aspect 2, wherein the starting time is an earliest time at which an RO associated with the one or more second RO groups is available, wherein the earliest time is after activation of the second set of ROs, and wherein the starting time is based at least in part on the one or more RO grouping rules being associated with forming the one or more second RO groups in accordance with the activation of the second set of ROs.

Aspect 4: The method of Aspect 2, wherein the starting time is an earliest time at which an RO associated with the one or more second RO groups is available, wherein the earliest time is in a next association pattern period after activation of the second set of ROs, and wherein the starting time is based at least in part on the one or more RO grouping rules being associated with forming the one or more second RO groups in accordance with the next association pattern period after the activation of the second set of RO groups.

Aspect 5: The method of Aspect 2, wherein the starting time is an earliest time at which an RO associated with the one or more second RO groups is available, wherein the earliest time is after an active RO group pattern associated with forming the one or more first RO groups, and wherein the starting time is based at least in part on the one or more RO grouping rules being associated with forming the one or more second RO groups after the active RO group pattern.

Aspect 6: The method of any of Aspects 1-5, wherein the one or more second RO groups include a first subset of second RO groups that include exclusively ROs from the first set of ROs and a second subset of second RO groups that include exclusively ROs from the second set of ROs in accordance with an independent RO grouping pattern.

Aspect 7: The method of Aspect 6, wherein the starting time is an earliest time at which an RO associated with the one or more second RO groups is available, wherein the earliest time is after activation of the second set of ROs, and wherein the starting time is based at least in part on the one or more RO grouping rules being associated with forming the one or more second RO groups in accordance with the activation of the second set of RO groups.

Aspect 8: The method of Aspect 6, wherein the starting time is an earliest time at which an RO associated with the one or more second RO groups is available, wherein the earliest time is in a next association pattern period after activation of the second set of ROs, and wherein the starting time is based at least in part on the one or more RO grouping rules being associated with forming the one or more second RO groups in accordance with the next association pattern period after the activation of the second set of RO groups.

Aspect 9: The method of Aspect 6, wherein the starting time is an earliest time at which an RO associated with the one or more second RO groups is available, wherein the earliest time is after an active RO group pattern associated with forming the one or more first RO groups, and wherein the starting time is based at least in part on the one or more RO grouping rules being associated with forming the one or more second RO groups after the active RO group pattern.

Aspect 10: The method of any of Aspects 1-9, wherein the control information is first control information, the method further comprising: receiving, from the network node, second control information that indicates one or more parameters associated with forming RO groups; and forming the one or more second RO groups over an RO group pattern, wherein the RO group pattern includes a number of associated pattern periods based at least in part on the control information and a capability of the UE.

Aspect 11: The method of Aspect 10, wherein the UE is associated with a first RO group pattern formation based at least in part on being associated with the first capability, and wherein the first RO group pattern formation is independent of a second RO group pattern formation for UEs not associated with the first capability.

Aspect 12: The method of Aspect 10, wherein the UE is associated with an RO group pattern formation based at least in part on being associated with the first capability, and wherein the RO group pattern formation is additionally for UEs not associated with the first capability.

Aspect 13: The method of Aspect 10, wherein the one or more parameters associated with forming RO groups comprises one or more of a number of PRACH preamble repetitions per RO group or a number of RO groups to form for a RACH procedure.

Aspect 14: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.

Aspect 15: An apparatus for wireless communication at a device, the apparatus comprising one or more memories and one or more processors coupled to the one or more memories, the one or more processors configured to cause the device to perform the method of one or more of Aspects 1-13.

Aspect 16: An apparatus for wireless communication, the apparatus comprising at least one means for performing the method of one or more of Aspects 1-13.

Aspect 17: A non-transitory computer-readable medium storing code for wireless communication, the code comprising instructions executable by one or more processors to perform the method of one or more of Aspects 1-13.

Aspect 18: A non-transitory computer-readable medium storing a set of instructions for wireless communication, the set of instructions comprising one or more instructions that, when executed by one or more processors of a device, cause the device to perform the method of one or more of Aspects 1-13.

Aspect 19: A device for wireless communication, the device comprising a processing system that includes one or more processors and one or more memories coupled with the one or more processors, the processing system configured to cause the device to perform the method of one or more of Aspects 1-13.

Aspect 20: An apparatus for wireless communication at a device, the apparatus comprising one or more memories and one or more processors coupled to the one or more memories, the one or more processors individually or collectively configured to cause the device to perform the method of one or more of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit, to a network node, one or more first repetitions of a physical random access channel (PRACH) preamble during one or more first random access channel (RACH) occasion (RO) groups, wherein the one or more first RO groups include a first set of ROs that are mapped to a synchronization signal block (SSB);
receive, from the network node, control information that activates a second set of ROs, wherein the second set of ROs are mapped to the SSB; and
transmit, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules.

2. The UE of claim 1, wherein the one or more second RO groups each include at least one RO from the first set of ROs and at least one RO from the second set of ROs in accordance with a joint RO grouping pattern.

3. The UE of claim 2, wherein the starting time is an earliest time at which an RO associated with the one or more second RO groups is available, wherein the earliest time is after activation of the second set of ROs, and wherein the starting time is based at least in part on the one or more RO grouping rules being associated with forming the one or more second RO groups in accordance with the activation of the second set of ROs.

4. The UE of claim 2, wherein the starting time is an earliest time at which an RO associated with the one or more second RO groups is available, wherein the earliest time is in a next association pattern period after activation of the second set of ROs, and wherein the starting time is based at least in part on the one or more RO grouping rules being associated with forming the one or more second RO groups in accordance with the next association pattern period after the activation of the second set of RO groups.

5. The UE of claim 2, wherein the starting time is an earliest time at which an RO associated with the one or more second RO groups is available, wherein the earliest time is after an active RO group pattern associated with forming the one or more first RO groups, and wherein the starting time is based at least in part on the one or more RO grouping rules being associated with forming the one or more second RO groups after the active RO group pattern.

6. The UE of claim 1, wherein the one or more second RO groups include a first subset of second RO groups that include exclusively ROs from the first set of ROs and a second subset of second RO groups that include exclusively ROs from the second set of ROs in accordance with an independent RO grouping pattern.

7. The UE of claim 6, wherein the starting time is an earliest time at which an RO associated with the one or more second RO groups is available, wherein the earliest time is after activation of the second set of ROs, and wherein the starting time is based at least in part on the one or more RO grouping rules being associated with forming the one or more second RO groups in accordance with the activation of the second set of RO groups.

8. The UE of claim 6, wherein the starting time is an earliest time at which an RO associated with the one or more second RO groups is available, wherein the earliest time is in a next association pattern period after activation of the second set of ROs, and wherein the starting time is based at least in part on the one or more RO grouping rules being associated with forming the one or more second RO groups in accordance with the next association pattern period after the activation of the second set of RO groups.

9. The UE of claim 6, wherein the starting time is an earliest time at which an RO associated with the one or more second RO groups is available, wherein the earliest time is after an active RO group pattern associated with forming the one or more first RO groups, and wherein the starting time is based at least in part on the one or more RO grouping rules being associated with forming the one or more second RO groups after the active RO group pattern.

10. The UE of claim 1, wherein the control information is first control information, wherein the one or more processors are further configured to cause the UE to:
receive, from the network node, second control information that indicates one or more parameters associated with forming RO groups; and
form the one or more second RO groups over an RO group pattern, wherein the RO group pattern includes a number of associated pattern periods based at least in part on the control information and a capability of the UE.

11. The UE of claim 10, wherein the UE is associated with a first RO group pattern formation based at least in part on being associated with a first capability, and wherein the first RO group pattern formation is independent of a second RO group pattern formation for UEs not associated with the first capability.

12. The UE of claim 10, wherein the UE is associated with an RO group pattern formation based at least in part on being associated with first capability, and wherein the RO group pattern formation is additionally for UEs not associated with the first capability.

13. The UE of claim 10, wherein the one or more parameters associated with forming RO groups comprises one or more of a number of PRACH preamble repetitions per RO group or a number of RO groups to form for a RACH procedure.

14. A method of wireless communication performed by a user equipment (UE), comprising:
transmitting, to a network node, one or more first repetitions of a physical random access channel (PRACH) preamble during one or more first random access channel (RACH) occasion (RO) groups, wherein the one or more first RO groups include a first set of ROs that are mapped to a synchronization signal block (SSB);
receiving, from the network node, control information that activates a second set of ROs, wherein the second set of ROs are mapped to the SSB; and
transmitting, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules.

15. The method of claim 14, wherein the one or more second RO groups each include at least one RO from the first set of ROs and at least one RO from the second set of ROs in accordance with a joint RO grouping pattern.

16. The method of claim 15, wherein the starting time is an earliest time at which an RO associated with the one or more second RO groups is available, wherein the earliest time is after activation of the second set of ROs, and wherein the starting time is based at least in part on the one or more RO grouping rules being associated with forming the one or more second RO groups in accordance with the activation of the second set of ROs.

17. The method of claim 15, wherein the starting time is an earliest time at which an RO associated with the one or more second RO groups is available, wherein the earliest time is in a next association pattern period after activation of the second set of ROs, and wherein the starting time is based at least in part on the one or more RO grouping rules being associated with forming the one or more second RO groups in accordance with the next association pattern period after the activation of the second set of RO groups.

18. The method of claim 15, wherein the starting time is an earliest time at which an RO associated with the one or more second RO groups is available, wherein the earliest time is after an active RO group pattern associated with forming the one or more first RO groups, and wherein the starting time is based at least in part on the one or more RO grouping rules being associated with forming the one or more second RO groups after the active RO group pattern.

19. The method of claim 14, wherein the one or more second RO groups include a first subset of second RO groups that include exclusively ROs from the first set of ROs and a second subset of second RO groups that include exclusively ROs from the second set of ROs in accordance with an independent RO grouping pattern.

20. An apparatus for wireless communication, comprising:
means for transmitting, to a network node, one or more first repetitions of a physical random access channel (PRACH) preamble during one or more first random access channel (RACH) occasion (RO) groups, wherein the one or more first RO groups include a first set of ROs that are mapped to a synchronization signal block (SSB);
means for receiving, from the network node, control information that activates a second set of ROs, wherein the second set of ROs are mapped to the SSB; and
means for transmitting, to the network node after activating the second set of ROs, one or more second repetitions of the PRACH preamble during one or more second RO groups, wherein the one or more second RO groups include the first set of ROs and the second set of ROs, and wherein a starting time to begin forming the one or more second RO groups is in accordance with one or more RO grouping rules.
